(19) United States
(12) Patent Application Publication
(10) Pub. No.: US 2015/0156148 A1
(43) Pub. Date: Jun. 4, 2015

(54) METHOD OF AUTOMATICALLY AUGMENTING AN ELECTRONIC MESSAGE

(71) Applicant: Daniel DOULTON, London (GB)

(72) Inventor: Daniel Doulton, London (GB)

(21) Appl. No.: 14/414,214

(22) PCT Filed: Jul. 10, 2013
(86) PCT No.: PCT/GB2013/051836

§ 371 Date: Jan. 12, 2015

(30) Foreign Application Priority Data
Jul. 10, 2012 (GB) 1212271.9
Oct. 17, 2012 (GB) 1218650.8

(51) Int. Cl. H04L 12/58

(52) U.S. Cl. CPC H04L 51/063; H04L 51/08

(57) ABSTRACT

A method of automatically augmenting an electronic message, such as an email message, webmail, IM message, posting on a social network site, webpage or message in any other medium or format with automatically generated content (a ‘Donation Mechanic’) within the footer of consumer emails. The recipient of the message can select the Donation Mechanic to trigger an event, such as a payment from the Brand to the Cause.

### BACKGROUND OF THE INVENTION

1. Field of the Invention

This invention relates to a method of automatically augmenting an electronic message, such as an email message, webmail, IM message, posting on a social network site, webpage or message in any other medium or format.

2. Description of the Prior Art

One context in which this invention can be implemented is in the field of donating to charities; conventionally, and perhaps cynically, charities might be said to have one core product—guilt. Charities might then reasonably be said to be adopting a 1950's push marketing model to distribute guilt. Like classic above the line advertising, this is both inefficient, expensive, and indiscriminate. Further, the conventional charitable giving model thrives on disasters, which, with even greater cynicism, might be said to be free PR, carried by primetime TV. Because of the dependence on disasters, charities often experience very unpredictable and spikey revenues. Some charities, especially those not in the top tier of charities, who account for the bulk of public donation, are dependent on a handful of corporate sponsors or on street ‘distributors’ who solicit with tins or donation forms.

Against this background, a new type of marketing called Cause Related Marketing has emerged. Brands know that doing good is valuable—it drives sales and brand affinity/loyalty. For several decades, brands have been increasingly associating themselves with causes in physical goods, e.g. Kraft™ food—‘Feed America’ campaign, Pampers™ nappies—‘malaria immunisation for African children’. The problem is that this only works for big brands and big charities who have the budgets to implement these campaigns and market them successfully. Inventory problem limits the relationship to one or two product lines only, and big name causes. Increasingly, Corporate Social Responsibility budgets (a tax write-off for most) are coming under real pressure for accountability with shareholders.

To sum up today's giving formula, one might say that giving is an expression of love. So, when I give to a cause, I feel an emotional reason to give—I want to give them some love. Yet I'm then asked to give some money instead. And, when I reach into my pocket, I'm asked to quantify my love into a precise amount of cash. Precise amounts of cash may also be a budget issue—perhaps I can only afford £5 right now. So what's really happened is that my emotion, my ‘want’ to help save a life, for example, has been quantified at only £5. So donating feels both cheap and unfulfilling. And it is driven by guilt, so it now involves two bad feelings.

And for the charities, the conventional approaches to obtaining public financial support and profile, namely mass mail shots, TV advertising, street-based sales people, are costly and inefficient.

This invention is predicated on the insight that charitable giving can, using modern computer-implemented means, be re-imagined in a disruptive, novel manner that overcomes the inefficiencies and lack of scalability of existing approaches. The same mechanism can also be deployed to provide Brands with a mass-scalable, computer-implemented process of endorsement and to provide Causes with a mass-scalable, computer-implemented process of advocacy for those Causes. This invention can make giving to Causes (or triggering Brands to give to those Causes) a part of people's everyday digital lives (as opposed to a rare, one-time event), just as searching using a search engine like Google™ is now a ubiquitous part of people's everyday, digital lives. It leverages individuals' growing sense of the value to those individuals (and not a large corporation) of their digital activities or presence.

The term Brand refers to any entity, typically a commercial entity but also an individual or community, that uses and is willing to pay (in money or some other benefit) for advertising or promotion or simply sponsor someone.

The term Cause refers to any entity, such as a beneficiary, charity, social cause or a specifically named entity (which could be an individual, or community or any other type of entity) that is willing to receive money or some other form of benefit from a Brand.

### SUMMARY OF THE INVENTION

The invention is a method of automatically augmenting an electronic message, such as an email message, webmail, IM message, posting on a social network site, webpage or message in any other medium or format with automatically generated content (a ‘Donation Mechanic’), such as text, graphics, audio or video, in which:

(a) a message sender, prior to sending the electronic message, selects or inputs to a computer some data, defining the type or name of a beneficiary, such as a charity or cause or a specifically named entity (a ‘Cause’), or permits the Cause to be remotely selected or confirmed;
(b) the computer and/or the remote server retrieve or dynamically create the Donation Mechanic, so that the Donation Mechanic includes or refers to or is otherwise based on the Cause;
(c) the computer and/or the remote server automatically inserts the Donation Mechanic into the electronic message.

In an implementation, the message sender, prior to sending the electronic message, selects or inputs to a computer some data, defining the type or name of an entity (the ‘Brand’) to be associated with the Donation Mechanic, such as being a sponsor that will pay for the Donation Mechanic, or permits the Brand to be remotely selected.

One implementation is called Free2Give™. In Free2Give™, ordinary users download and install an app that automatically adds a simple mechanic of a bird to the bottom of their emails, see FIG. 1 and FIG. 5. The user has previously defined a Cause associated with the bird (Or it may have been set by a Brand beforehand). The bird is associated with an intriguing message, in this case, as shown in FIG. 2, it reads ‘Release 65p now’. The email is then sent and received. When the email recipient clicks on the bird, then an event such as a donation to the Cause is triggered; it is made by a Brand on behalf of the message sender.

The donation quantity is shown as being carried by the bird in flight to the Cause, see FIG. 3. However the currency is not always a donation. It could be anything from voucher codes, QR codes, loyalty points, a quantity of something etc (these are likely ‘Treats’—some kind of benefit)—the mechanic may also show other data about what will be triggered for the Cause when they engage/click—donation, number of people, events, hours committed, crates given, 1000s of free hosting hours, etc. . . . or other Treat options to choose from (e.g. 6 prizes, 7 free flights, 15 cases of Cola, size of network, campaign statistic, etc. . . . )). Some causes and brands may want their names or logo's connected to the Donation Mechanic. The Donation Mechanic design remains flexible to work with these requests. It is a framework in which the 3 parties are brought together in a proposition designed to engage the viewer/reader the Free2Give™ Donation Mechanic Framework™.

The Free2Give Donation Mechanic Framework:

Context:

It is a framework in which the 3 parties are brought together in a proposition designed to engage the viewer/reader to enhance the outcome already created/presented.

Content:

The execution can be in a wide range of formats/styles/mediums as long as they achieve the following.

### Formulation—

Brand, Cause, Sender—coming together in a graphic (mechanic) which creates sponsorship for the nominated Cause
It provides the reader/recipient with the option to add to/enhance this by simply interacting with the graphic (mechanic)—triggering further sponsorship for the Cause

### Proposition—

Doing good, every message/view/click, for free
Branded Free2Give
Invitation to also ‘Be Free2Give’
Overall, it's an expression of individual freedom
The proposition is about engaging to release more good, freely—i.e. with no additional conditions or donations/payments by the recipient/reader
Further messaging about the value or meaning of the proposition

### Engagement

It provides engagement for the reader/recipient including: doing good for free, finding out how the 3 parties have come together, seeing a brand and/or cause message, receiving a Treat from any of the 3 parties
Engagement can be either
   implicit—namely iconic presentation of the concept with a minimal suggestion of what the outcome is upon engagement (e.g. 65p) or
   explicit—namely visible information about who and why the 3 have come together and how to amplify the outcome upon engagement (click-through)

### Format—

The format of 3 items coming together in a personal message identifies the concept of Free2Give
This may vary and be styled or customised to each user/cause/brand, etc. . . . but is a recognisable format
The Free2Give brand font elements are used to create objects that intrinsically connect with Free2Give and its ideal(s)
It communicates that there is always something far larger behind it, rather than answer everything in one visual—it is engaging
The size of all artwork needs to visually balance as if it is a signature or moniker in a sender's message—it is to be ‘worn’ with pride as if it is a badge or social sign of value and meaning, not a banner advert or full page display
Fail safe—it will fail back to text where the viewer/recipient's device/app is unable to display graphics and provide native links (URLs) for engagement

After the email recipient has checked the Donation Mechanism, the email recipient is shown on his computer which Cause benefits. In FIG. 4, the charity Oxfam™ is shown to have benefitted by 65p from the Coca-Cola Company. The recipient is also offered some kind of a benefit or Treat from the Brand; in FIG. 3, it is free coke for a month—this will typically lead the recipient to visit the website of the Brand to redeem the Treat, enabling the Brand to start a direct dialogue with the email recipient.

The Free2Give™ augmented messaging platform is both a novel approach to augmenting the functionality of messaging functions and also provides transformational advantages to Causes, Brands and People:
CAUSES WIN: Transform their database & social media followers into incremental, recurring revenue
BRANDS WIN: Engaging ROI model that mobilises loyalists, leading to a direct route to sales (and enables the brand to be seen in a new light)
PEOPLE WIN: Liberates an individual to become Free2Give™ and free to share

The Free2Give™ augmented messaging platform deepens relationships to create a new ‘advocacy’ channel with three core aspects:
Converts CSR budget into ROI & offers all Brands a new product they can invest in
Mobilises social bases into revenue generating Advocates
Long-term, helps Causes and Brands to create their own Advocacy Channels—an asset they own

To summarise: The Free2Give™ augmented messaging platform therefore provides advertising opportunities to Brands through the automated placement of pre-stored or automatically and dynamically generated content (the Donation Mechanic), typically placed within the footer of consumer emails; this approach may be extended to Twitter tweets, posting on social networks and online link sharing with brand advertising. FIG. 5 shows this. Each brand message is associated with a donation to a Cause, such as a charity.

Brands pay for the service using traditional CPV/CPC type per-transaction methods, with a high proportion of the transaction fee paid going to the ‘endorsed’ or supported charity. The charity/brand adverts are accompanied by an automated statement on behalf of the consumer, such as “I've given freely to charity-X, thanks to brand-Y and Free2Give™”, and this composite is called a ‘Free2Give™ Social Signature’.

The Free2Give™ augmented messaging platform is free to use for charities and consumers. The hook for consumers to use the service is that through their normal email and social messaging activities, they are generating income for charities at no cost or effort to themselves. Donations to Causes are made on behalf of ordinary users by a Brand of their choice.

The Free2Give™ augmented messaging platform enables ordinary users of technical messaging platforms like email and social networking sites to now give to causes, everyday, for free, and free of guilt. Causes enjoy a massively scalable recurring income source with zero acquisition cost. Brands enjoy massively scalable trusted advocacy of their brands by individuals who allow their brands to be inserted into the messages to friends and colleagues and effective measurement and tracking of their CSR and Marketing budgets.

This frictionless creation of strong brand advocates can grow virally. It is frictionless because a message incorporating a Donation Mechanic for a specific Brand (and Cause) can be immediately and at zero cost forwarded by a recipient to one or a thousand further recipients in a chain of recipients: the Donation Mechanic is maintained or preserved as the message is forwarded to new recipients in a chain or channel of communication.

Furthermore, each sender and recipient can be automatically provided with some kind of benefit from the Brand (e.g. discount vouchers, or anything else of interest or value)—what we refer to as a ‘Treat’. Distribution and uptake of Treats can be automatically tracked at a server since the Treat assets can be uniquely identified with some form of unique, trackable data signature that is fed back to a server once the Treat is activated; Brand owners can hence see who is now actively engaging with their products or services since users need to provide some personal information to receive their Treats. Also, the Mechanic and Treat can be dynamically changed by event, user, time, etc. . . . so each one is uniquely personalised to the user/recipient.

Consumer users of the service (e.g. people who send and receive messages incorporating Donation Mechanics) can readily track how much money has been paid to the Causes they support by virtue of the Free2Give™ system tracking the Donation Mechanic interactions and collating this data in a landing page website, which we refer to as the ‘My Good’ meter or webpage. The MyGood landing page can be easily reached through a button or link that opens the landing page. This page, see FIG. 6A and FIG. 6B, can be thought of as a dashboard that measures:
For subscribers
   History of how much raised
   Donate & access to offers
   Invite others to join
   View personal offers ‘Treats’
For Brands & Causes
   Push their news to users
   Additional donations (Causes)
   Product information (Brands)

Brand customers are added to the Free2Give™ service by the Free2Give™ Limited company, and will then be allowed to maintain one or more Donation Mechanics to be placed at the foot of consumer emails. Brands will be able to sign up for the service themselves, and will also be able to maintain adverts for placement in other messaging or social media, such as in consumer Tweets or Facebook™ posts.

Charity customers will similarly be signed-up for the service by Free2Give™ Limited initially, with a capability to self-register, and will again maintain one or more adverts for inclusion in consumer email or social messaging.

Consumers will register for the service at either the Free2Give™ website, or at a white labelled website running for one of the Brands; either before or after downloading a plugin for their Internet browser(s) which performs the function of adding the ‘Donation Mechanic’ into the footer of popular webmail products.

Initially a simple randomization system will be used to select and pair Charities and Brands for each Donation Mechanic generated, whilst the selection algorithm will increase in complexity over time, in particular to allow brands to participate in ‘AdWords style’ bidding for placement alongside specific Charities, or to target specific Consumer segments.

Consumers, Brand and Charities will each be able to opt-out of nominated other parties, so allowing Consumers to disassociate themselves from Brands or Charities that they aren't willing to support; whilst Brands and Charities can also nominate ethical mismatches. Each party to the service will have a number of reports that demonstrate their funds raised or given to date.

Operationally, a Cause will simply need to:
Create an account with Free2Give™ as a Beneficiary
Provide artwork (logos) and specific resources to use when Free2Give™ constructs Donation Mechanics including this Cause as beneficiary

It is envisaged that this may be semi-automatic, namely a user may add any Cause they choose, the Cause is notified and their permission sought, Free2Give™ accrues donations to them and settles with them periodically.

Optionally, they can:
Create or provide specific landing pages they want to drive engagement to
Create or provide specific incentives or awards (Treats) they'd like to give to users and recipients who participate
Communicate the availability/their affiliation with Free2Give™ to their bases, sponsors, other interested parties. This may be part of a standard campaign in which Free2Give™ is included as an element in their marketing/campaign mix. It may also be a permanent feature of their website, newsletters, regular communications, partner sites, etc. . . .
Communicate their endorsement to brands whom aren't necessarily sponsors and sell them access to their base using Free2Give™
Create custom versions of the Donation Mechanic using the Free2Give™ Donation Mechanic Framework and even charge for their use (i.e. limited edition Pink hats on Birdie to put on the footer of your messages at £10 each—goes to campaign Y)
Share their Donation mechanic with sign-up links via their communications channels (e.g. mail, web, social media, etc. . . . )
Route their ‘share’/‘recommend’ (Like, share, etc. . . . ) links all via Free2Give™ to promote their brand sponsors who support them.

Operationally: Access to a login page to monitor activity, amounts raised, number of people using/receiving/engaging/provisioning, etc. . . . change parameters such as white/black lists, campaign names, content/inventory used, URLs, etc. . . .

A Brand will simply need to
Create an account with Free2Give™ as a Sponsor
Provide credit or commitment to a certain amount they'll contribute to a campaign/cause and choose the right product
Create or provide specific landing pages they want to drive engagement to
Create or provide specific incentives or awards (Treats) they'd like to give to users and recipients who participate

Optionally they can
Communicate the availability/their affiliation with Free2Give™ to their bases, affiliates, other interested parties. This may be part of a standard campaign in which Free2Give™ is included as an element in their marketing/campaign mix. It may also be a permanent feature of their website, newsletters, regular communications, partner sites, etc. . . .
Create custom versions of the Donation Mechanic using the Free2Give™ Donation Mechanic Framework and even charge for their use (i.e. limited edition Stussy shoes to put on the footer of your messages at £10 each—goes to Cause X)
Share their Donation mechanic with sign-up links via their communications channels (e.g. mail, web, social media, etc. . . . )
Route their ‘share’/‘recommend’ (Like, share, etc. . . . ) links all via Free2Give™ to promote and support chosen causes.

Operationally: Access to a login page to monitor activity, amounts spent/credit, amounts raised, number of people using/receiving/engaging/provisioning, etc. . . . change parameters such as white/black lists, campaign names, content/inventory used, URLs, etc. . . .

A high-level schematic Architectural Overview of the Free2Give™ augmented messaging platform is at FIG. 7. A system view of the fully managed Free2Give™ service is at FIG. 8.

### BRIEF DESCRIPTION OF THE FIGURES

The Figures show the following features of the Free2Give augmented messaging platform.

FIG. 1 shows how the Free2Give app automatically adds a simple mechanic of a bird to the bottom of a user's emails

FIG. 2 shows how the Donation Mechanic includes an intriguing message, in this case, as it reads ‘Release 65p now’

FIG. 3 shows a computer display showing the donation quantity being carried by the bird in flight to the Cause.

FIG. 4 shows how the recipient is informed of the identity of the Cause they have just supported by clicking on the Donation Mechanic and what their Treat is.

FIG. 5 is a schematic showing what the user does to get started.

FIGS. 6A and 6B show the MyGood landing pages; these shows donation metrics for a user.

FIG. 7 is a high-level schematic Architectural Overview of the Free2Give™ augmented messaging platform.

FIG. 8 is a system view of the fully managed Free2Give™ service.

FIG. 9 shows the discovery part of the user journey—how they discover the existence of the Free2Give system.

FIG. 10 shows the provisioning part of the user journey—how the Free2Give app is installed on the user's computer.

FIG. 11 shows how the Free2Give web account is accessed.

FIG. 12 shows the Free2Give mobile app icon.

FIG. 13 shows what happens when a message is sent.

FIG. 14 shows what happens when a message is received.

FIG. 15 shows how links can be shared.

FIG. 16 is a schematic illustrating how users publish their ‘social badge’ to others.

FIG. 17 is a schematic illustrating the ‘Social Capital Exchange’ model.

FIG. 18 is a schematic showing how advocates are mobilised using the Free2Give system.

FIG. 19 illustrates the three-party interaction that underlies the Free2Give system.

FIG. 20 is a schematic illustrating the ‘Next Generation Marketing & Media Platform’.

FIG. 21 is a schematic illustrating ‘Creating the ad-eco-system: for messaging’.

FIG. 22 is a schematic illustrating the Free2Give Business model.

FIG. 23 is a schematic illustrating the ‘360° user view’ model.

FIG. 24 shows the impact of Free2Give on a Cause's direct giving metrics.

FIG. 25 is a schematic of the Free2Give beneficial value chain & simple commercial framework.

FIG. 26 shows the Free2Give web based analytics tools & access to user details.

FIG. 27 shows the Free2Give system's Key Performance Indicator outputs.

FIG. 28 shows how the Free2Give system develops an advocacy channel.

### DETAILED DESCRIPTION

### 1. Overview and Key Features

As explained above, this invention is a method of automatically augmenting an electronic message, such as an email message, webmail, IM message, posting on a social network site, webpage or message in any other medium or format with pre-stored or dynamically generated content (a ‘Donation Mechanic’). It is in effect an advertising channel for Brands that works through the placement of the Donation Mechanic, e.g. Cause related content, within the footer of consumer emails; this approach may be extended to Twitter™ tweets and online link sharing with brand advertising. The recipient of the message can click-on the Donation Mechanic and that act triggers the payment from the Brand to the Cause.

In later sections, we will describe the following aspects of the Free2Give™ system:

Section 2. System Flow—User journey
Section 3. Trading Presence for things you care about: the Social Capital Exchange

### Section 4. Product Requirements

### Section 5. Business Focussed Overview

In this Overview and Key Features sections, we will describe the following specific features of the Free2Give™ augmented messaging platform:

### Provisioning

Cause selection
Brand selection
Donation Mechanic creation

### Engagement Items

### Payment to a Cause

### Treats

### Tracking

### Landing Page

Sharing Links that include a Donation Mechanic

### Sharing Presence

### Social Capital Exchange

IT architecture

Taking these in turn, the key features are as follows. At its broadest, the invention is a method of automatically augmenting an electronic message, such as an email message, webmail, IM message, posting on a social network site, webpage or message in any other medium or format with pre-stored or dynamically generated content (a ‘Donation Mechanic’), such as text, graphics, audio or video, in which:

(a) a message sender, prior to sending the electronic message, selects or inputs to a computer some data, defining the type or name of a beneficiary, such as a charity or cause or a specifically named entity (a ‘Cause’), or permits the Cause to be remotely selected or confirmed;
(b) the computer and/or the remote server retrieve or dynamically create the Donation Mechanic, so that the Donation Mechanic includes or refers to or is otherwise based on the Cause;
(c) the computer and/or the remote server automatically inserts the Donation Mechanic into the electronic message.

Further, optional features, each of which may be included with any one or more other features include the following:

### Provisioning

a plug-in or app, downloaded to the computer, enables the automatic augmenting of the electronic message.

### Cause Selection

the message sender selects one or more Causes from a list of possible Causes displayed on the computer.
a rules-based engine determines what Cause or Causes are appropriate to assign to the Donation Mechanic in the message.
the rules based engine determines dynamically for each message what Cause or Causes are appropriate to assign to the Donation Mechanic in the message.
the Cause is randomly selected at the message sender's computer or the remote server.
the computer and/or the remote server automatically selects the Cause based on the closest match between the profile of the message sender and criteria set by various Causes.
the computer and/or the remote server automatically selects the Cause based on the location of the message sender.
the computer and/or the remote server automatically selects the Cause based on presence information associated with the message sender, such as mood or status.
the computer and/or the remote server automatically assigns a Cause that has been pre-selected.
the computer and/or the remote server automatically allocates the same Cause to all active message bearers or message mediums associated with the message sender.
the computer and/or the remote server automatically allocates different Causes to different active message bearers or message mediums associated with the message sender.

### Brand Selection

the message sender, prior to sending the electronic message, selects or inputs to a computer some data, defining the type or name of an entity (the ‘Brand’) to be associated with the Donation Mechanic, such as being a sponsor that will pay for the Donation Mechanic, or permits the Brand to be remotely selected.
message sender chooses one or more Brands from a selection list showing which Causes can be associated with various Brands
a rules-based engine determines what Brand or Brands are appropriate to assign to the Donation Mechanic in the message.
the rules based engine determines dynamically for each message what Brand or Brands are appropriate to assign to the Donation Mechanic in the message.
message sender can opt-out of being associated with specific Brands or Causes, or categories of Brands or Causes.
the computer and/or the remote server automatically selects the Brand based on the closest match between the profile of the message sender and criteria set by various Brands.
the computer and/or the remote server automatically selects the Brand based on the location of the message sender.
the computer and/or the remote server automatically selects the Brand based on presence information associated with the message sender, such as mood or status.
the computer and/or the remote server can automatically choose a Brand for association with a specific Cause and/or user profile based on the rates provided or bid by various potential sponsors, such as CPA (click-per-action), CTR (click-through-rate), CPR (click per rating), CPV (click per view), CPM (cost-per-mille), CPC (cost per click) when bidding to be associated with specific Causes, or categories of Causes, or message sender profiles or demographics, or message recipient profiles or demographics.
the computer and/or the remote server automatically assigns a Brand that has been pre-selected by a Cause.
the computer and/or the remote server can automatically block certain Brands from being associated in a message with certain Causes, or certain users, or certain recipients.
the computer and/or the remote server automatically allocates the same Brand to all active message bearers or message mediums associated with the message sender.
the computer and/or the remote server automatically allocates different Brands to different active message bearers or message mediums associated with the message sender.
the computer and/or the remote server automatically and without the message sender deliberately composing a message, publishes or causes the Donation Mechanic to be published in a message, such as an email message, webmail, IM message, posting on a social network site, webpage or message in any other medium or format.

### Donation Mechanic Creation

the computer and/or the remote server retrieves or dynamically creates the Donation Mechanic based on various parameters (‘Donation Mechanic Parameters’).
the Donation Mechanic Parameters include one or more of the following: preferences or settings of the message sender and/or recipient, nature of any product, service, gift or award described by the Donation Mechanic; time of day the message is created or sent; day of the week the message is created or sent; whether the message is created on a day of public significance, such as a public holiday, Mother's Day, Dia del Niño, Royal wedding, language of the message; an amount of money (or any form of currency/value) to be paid, donated or given by the Brand if the Donation Mechanic is sent to or acted on by a recipient; geographical location of the message sender and/or recipient; nature of or attributes defined by the Cause; nature of or attributes defined by the Brand.
the Donation Mechanic is assembled from inventory assets including graphics defining the appearance of the Donation Mechanic; the name or other identifier of the Brand; the name or other identifier of the Cause; specific outcomes such as the monetary value (or currency/value) to be attributed to the message; offers or awards for the message sender and/or message recipient (‘Treats’).
the inventory assets are each associated with a unique link to enable full interactivity and tracking of how and when those assets are received/viewed and interacted with.
the remote server passes back to the message sender's computer the content for the Donation Mechanic and the computer then automatically adds the Donation Mechanic to the electronic message.
a client-side application on the message sender's computer interacts with an application, such as email application, social media app or browser on that computer, that generates the message, in order to automatically insert the Donation Mechanic into the message.
the message sender's computer automatically inserts the name of a specific Cause or type of Cause into the Donation Mechanic so that the message sender can see that name when reading the outgoing or sent message.
the message sender's computer automatically inserts the amount of money (including other currency or value) to be associated with that message into the Donation Mechanic so that the message sender can see that amount when reading the outgoing or sent message.
the message sender's computer automatically inserts the name of the Brand into the Donation Mechanic so that the message sender can see that Brand when reading the outgoing or sent message.
the message is sent from the computer with a code (unique link (URL)) that uniquely identifies the Donation Mechanic such that, when the message is received at a recipient's computer, then the recipient's computer is able to automatically download the Donation Mechanic from the remote server and automatically insert it into the message as displayed on the recipient's computer.
the message recipient's computer automatically inserts the name of a specific Cause into the Donation Mechanic so that the message recipient can see that name when reading the incoming or received message.
the message recipient's computer automatically inserts the amount of money to be associated with that message into the Donation Mechanic so that the message recipient can see that amount when reading the incoming or received message.
the message recipient's computer automatically inserts the name of the Brand to be associated with that message into the Donation Mechanic so that the message recipient can see that name when reading the incoming or received message.
the Donation Mechanic does not include any reference to the Brand or Cause when the message is created, sent or received, and the Brand/and/or Cause is only revealed after the recipient has selected or otherwise interacted with the Donation Mechanic or message.
the message recipient's computer does not automatically insert the name of the Brand to be associated with that message into the message, but when the message recipient selects or clicks on a portion of the received message, such as the Donation Mechanic, then the message recipient's computer sends a signal to the remote server which in turn returns data that identifies the Brand, such as by providing a URL that automatically leads to the opening of a web site or web page associated with the Brand, insertion into social network content, or any other process that results in the Brand being identified.
when the message recipient selects or clicks on a portion of the received message, such as the Donation Mechanic, then the message recipient's computer sends a signal to the remote server which in turn returns data that defines a reward for the recipient.
when the message recipient selects or clicks on a portion of the received message, such as the Donation Mechanic, then the message recipient's computer sends a post to a website.
the Donation Mechanic is automatically inserted in the footer of an email message or anywhere else the user deems.
the Donation Mechanic is automatically inserted in a tweet on Twitter™, an entry on FaceBook™ or Google+™ or any other social network.
the Donation Mechanic is automatically inserted in the message generated when sharing a link to a website or any web resource.
the Donation Mechanic is automatically inserted on a webpage.
an Application or plug-in enables a user to create a Donation Mechanic which replaces a conventional signature.
the Donation Mechanic can be custom designed by a user or third party.

### Engagement Items

the Donation Mechanic includes a portion, region or object, such as a plant or animal (‘Engagement Item’), that, when selected by the recipient, causes a new window, such as a browser window, to open and display information relevant to the Brand and/or Cause.
the Engagement Item, that animates when the Donation Mechanic is selected by the recipient to portray the delivery of a benefit to a Cause.
the Engagement Item indicates, includes or is associated with the nature of the benefit that will be provided to the Cause by the Sponsor if the recipient selects the Engagement Item and/or has in the past been provided by the Sponsor to the Cause.
the Engagement Item indicates, includes or is associated with the identity(ies) of the people who will benefit if the recipient selects the Engagement Item and/or have in the past benefitted.
the Engagement Item indicates, includes or is associated with an amount of money or other form of sponsorship or benefit that a Brand is willing to provide to the Cause if the recipient selects the Engagement Item.
the Engagement Item indicates, includes or is associated with the number of times an Engagement Item associated with a specific Brand and/or Cause has been selected, or the number of events, or followers, or donors, or other network statistics.
the Engagement Item includes or is associated with an amount of money or other form of sponsorship or benefit, a Brand is willing to provide to the Cause, if the recipient selects the Engagement Item.
the Engagement Item enables the message recipient to directly receive an offer, reward, points to a loyalty scheme, or other benefit (a ‘Treat’).
the Engagement Item includes a QR code (or other form of unique, trackable identifier) that enables the message recipient to directly receive a Treat or indicate or provide an offer, such as a coupon or other form of engagement or loyalty benefit.
if the message is forwarded to another recipient, then a new Donation Mechanic is created that may match the original Donation Mechanic, but does not have to, for example instead dynamically adapting to match the context of the sender/recipient pair.

### Payment

when the message recipient receives, views or selects or clicks on the Donation Mechanic using his computer, then that computer sends a message to the remote server or another remote server that causes a signal to be sent to a payment server, defining or triggering a payment to the Cause.

### Treats

the Engagement Item enables the message recipient to directly receive an offer, reward or other benefit (a ‘Treat’) by selecting the Engagement Item.
the computer and/or remote server automatically provides a Treat (or accumulates credits which could trigger a Treat) to the message sender when the message sender creates or sends a message including a Donation Mechanic.
the computer and/or remote server automatically re-directs a web browser on the message sender's computer to a website associated with the Brand when the message sender accepts a Treat.
the recipient's computer and/or remote server automatically provides a Treat to the message recipient when the message recipient engages with the Engagement Item, for example by selecting it.
the recipient's computer and/or remote server automatically re-directs a web browser on the message recipient's computer to a website associated with the Brand when the message recipient accepts a Treat.
the Sender and Recipient may also receive a Treat from the Cause or potentially a 3^{rd} party to the entire relationship.

### Tracking

when the message recipient selects an Engagement Item, a unique tracking URL enables the click details to be recorded, and the message recipient is re-directed to a corresponding destination web site.
the unique tracking URL is pre-generated by the server at message formation by the plug-in/app, so that, when the viewer clicks it, it connects to the remote server(s) and then they generate the appropriate re-directs to ‘land’ them at the right location/resource, so that re-directs/destinations are dynamically managed in real-time and tracking is also recorded in real-time.

### Landing Page

the Message sender can view all money (or equivalent currency/units) that he or she has raised for Causes on a website.
The Website also displays statistics such as one or more of: the number of messages sent, viewed, clicked, shared and how many people have signed up from their base and are using Donation Mechanics, how much this network has collectively raised.
users/recipients can also gift, trade-in or donate their Treats to a Cause(s) and to other users.
the computer and/or remote server automatically re-directs a web browser on the message sender's computer to a website associated with the Brand when the message sender accepts a Treat that is displayed on the website.
   Sharing Links that Include a Donation Mechanic
the computer or the remote server detects when a user selects a ‘share’ function or equivalent form of recommending/endorsement/sharing for any kind of content, such as a website, social media, or content personal to the user and then the computer and/or remote server automatically inserts a Donation Mechanic into whatever mechanism is used for the share function.
the message sender dynamically chooses as a Cause the author, content creator, publisher or owner of on-line published material, such as a web published creative work, such that when the message sender sends a message with a shared link to the online published material, then a Donation Mechanic is created that, when selected or acted on by a message recipient, provides a benefit, paid for or provided by a Brand, to the Cause.
the selection of a Cause is either automatic, such as occurs if the computer or remote server automatically detects what website they are recommending, or manual, such as occurs when a user manually selects that Cause.
an app or plug-in running on the message sender's computer detects when a user selects a ‘share’ function or equivalent when browsing a web page and then automatically inserts the Donation Mechanic into the message that is automatically generated with a shared link to the web page.
an app or plug-in running on the message sender's computer detects when a user selects a ‘like’, ‘recommend’ or a ‘share’ function or equivalent in relation to content on a web page of a social networking site, such as Facebook™ or Twitter™, and then automatically inserts the Donation Mechanic into the message or posting that is automatically generated with a shared link to that content.

### IT Architecture

Remote server includes one ore more servers that perform the following functions: provisioning client applications, subscription management, analytics and CRM, media management

Further independent aspects of the invention include the following:

### Presence—Independent Invention

A method of sharing personal presence information in which:

(a) a user selects or inputs to a computer some data, defining the type or name of a beneficiary, such as a charity or cause or a specifically named entity (a ‘Cause’), or permits the Cause to be remotely selected;
(b) the user also selects or inputs data, defining the type or name of an entity (the ‘Brand’), being a sponsor that will provide a benefit in exchange for presence information of or linked to the user, or permits the Brand to be remotely selected;
(c) the computer provides, to a remote server, data enabling the Cause and the Brand to be determined; and
(d) the computer and/or remote server determines when a signal is sent that triggers or is otherwise associated with a payment from the Brand to the Cause.
Presence information includes any of: location of the user, activity user undertaking, time/date/event for the user, mood of the user, websites liked by the user, social media content liked by the user.
the Cause includes any of: the user, a charity, a publisher of web content, a reviewer of web content, a creator of web content, a community, a person/individual.
the Benefit includes any of: money, credit, vouchers, awards, game boosters (?) or enhancements.

### Social Capital Exchange—Various Independent Inventions

A computer-implemented communication process, such as sending a message, posting to a social network, or sharing of a webpage, in which the process has a primary function to provide written information and also has a further function to enable the creator of the communication to exploit their reputation, knowledge, trustworthiness, or credibility (‘Social Capital’) by virtue of the medium of the communication, such as email message or social network posting, being automatically augmented by a computer using any of the above methods of automatically augmenting an electronic message.

Method of composing an electronic message in which the message creator first manually composes a message and then that message is automatically augmented with a Donation Mechanic in a computer implemented process controlled by a processor.

Method for enabling mass-scale advocacy of Causes comprising the computer-implemented steps of automatically augmenting an electronic message using any of the above methods.

Method for enabling mass-scale advocacy of Causes comprising the computer-implemented steps of automatically augmenting an electronic message with a Donation Mechanic, in which the Donation Mechanic is maintained or preserved as the message is forwarded to new recipients in a chain or channel of communication.

Method for enabling mass-scale endorsement of Brands, comprising the computer implemented steps of automatically augmenting an electronic message using any of the above methods.

Method for enabling mass-scale endorsement of Brands comprising the computer implemented steps of automatically augmenting an electronic message with a Donation Mechanic, in which the Donation Mechanic is maintained or preserved as the message is forwarded to new recipients in a chain or channel of communication.

A message that has been augmented using any of the above methods.

### Section 2. System Flow—User Journey

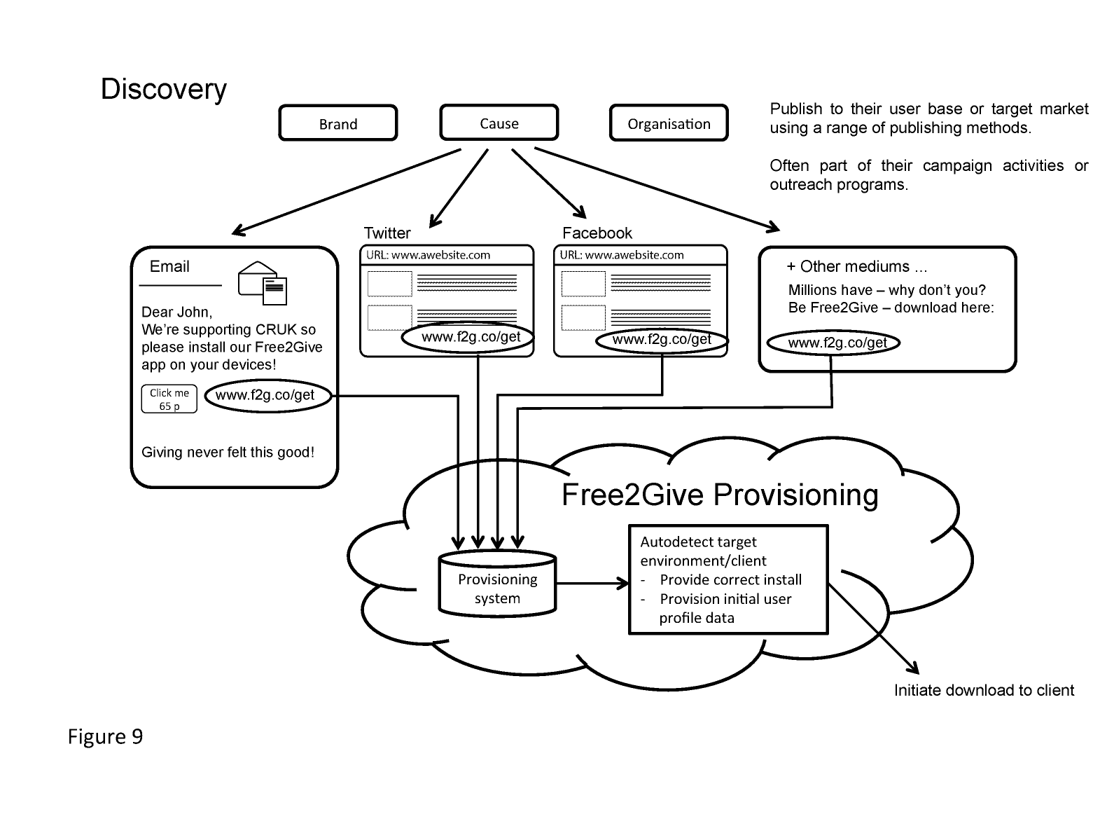

FIG. 9 is a schematic showing the User Journey—Discovery. An initial problem is how to make users aware of the service. We solve this by enabling any of the Brands, Causes, and Organisations (an organisation is a generic term for any entity that wishes to use the Free2Give™ platform) to publish to their user base or target market using a range of publishing methods, such as email, Twitter™, Facebook™ and any other medium—the purpose being to promote the Free2Give™ app and to encourage users to download and install that app on their computers (i.e. smartphones, laptops, PCs, tablets etc).

The published message will include a ‘sign-up’ link that a user can select; when he or she does so, then the Free2Give™ provisioning system auto-detects the target environment or client device and provides the correct install of the plug-in or app to the client device, and provisions the initial user profile data.

Recipients will be offered the sign-up link:
When they click-through on the Free2Give™ icon/mechanic
On ‘landing pages’
Websites: Free2Give™, Partners, Distributors, etc. . . .
When sent an invitation mail from other users
In adverts or promotions for Free2Give™

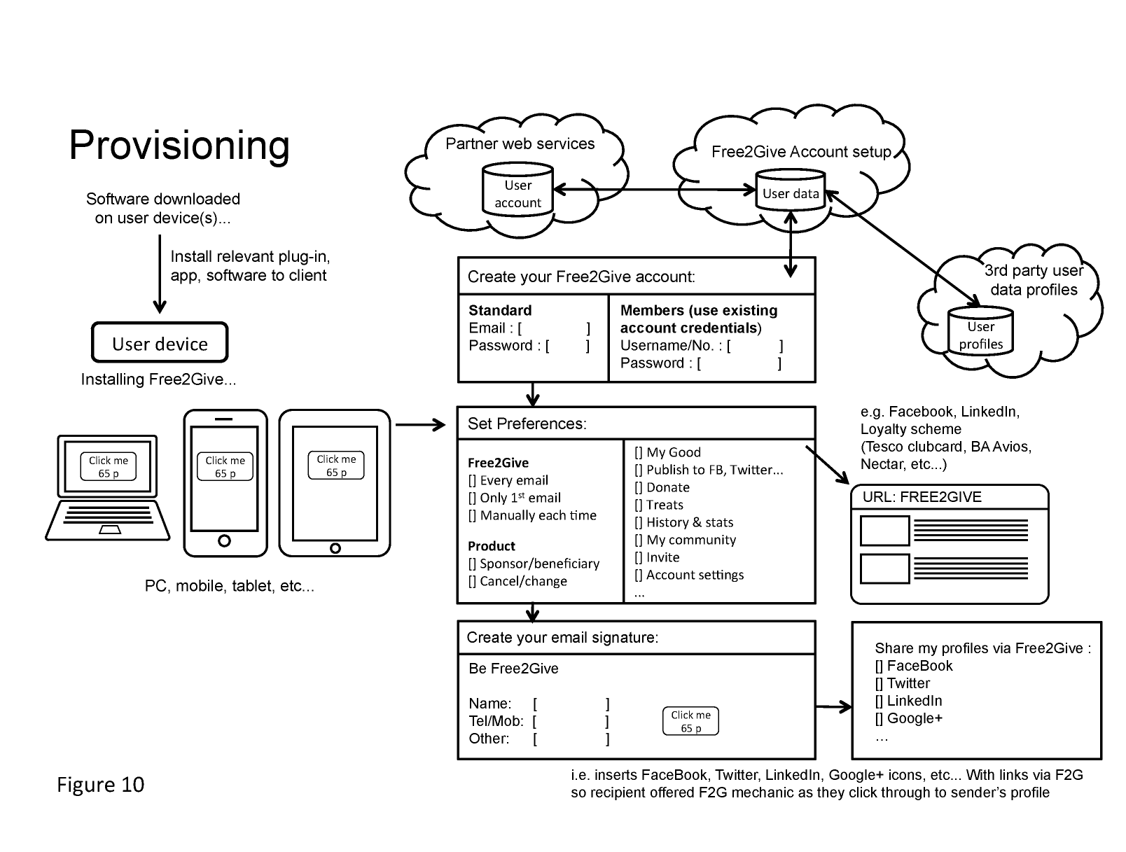

FIG. 10 is a schematic showing the User Journey—Provisioning. The provisioning process itself is a conventional plug-in/app download and install process. Once the Free2Give™ app is installed, the user can create their Free2Give™ account and can set preferences, such as selecting how frequently a Donation Mechanic is added (e.g. every mail, manually etc). Also, the user can readily create its electronic signature (a process that many users find challenging in a conventional email application). The user can choose whether to automatically share profiles via Free2Give™ in various social network sites, such as FaceBook etc.—i.e. inserts FaceBook™, Twitter™, LinkedIn™, Google+™ icons, etc. . . . with links via Free2Give™ so recipients are offered the Free2Give™ mechanic (i.e. Donation Mechanic) as they click through to the sender's profile. Once installed, the Free2Give™ plug-in automatically inserts the Free2Give™ mechanic into each message; in this FIG. 10 the Donation Mechanic is represented by the box ‘Click me 65p’. Note that neither Brand nor Cause are mentioned in this version of the Free2Give™ Donation Mechanic.

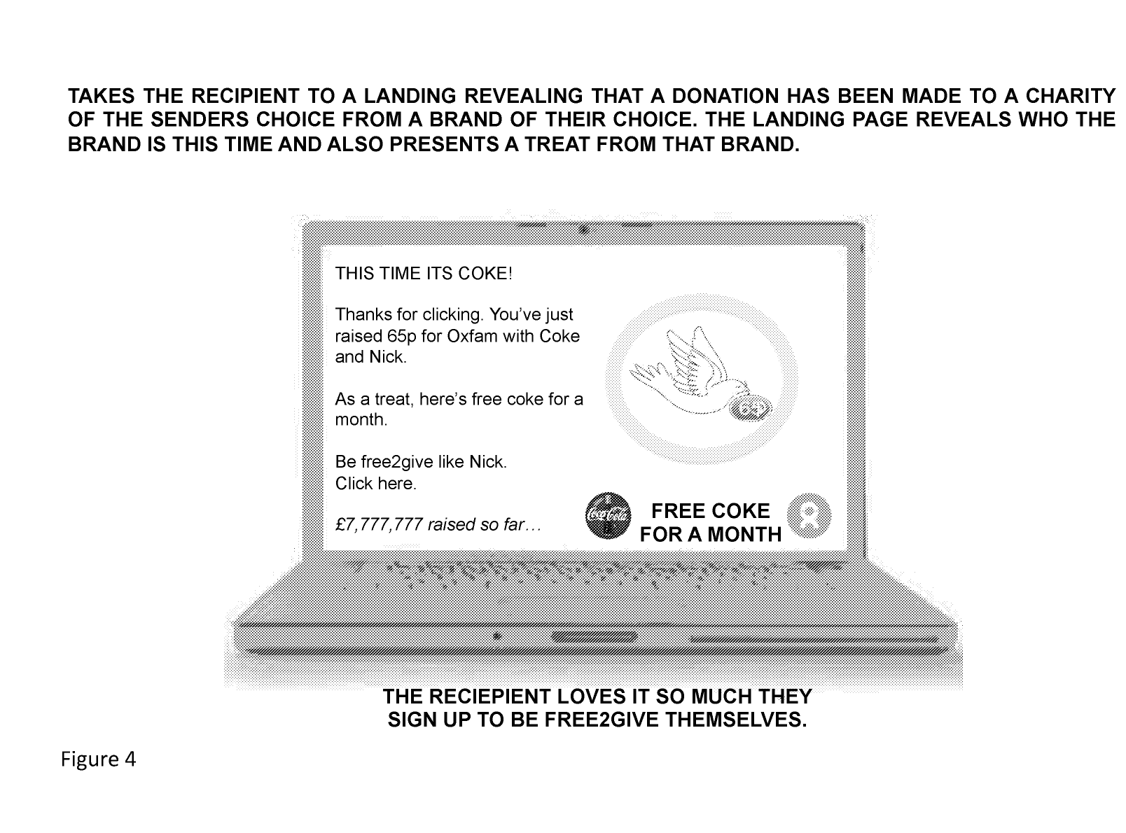

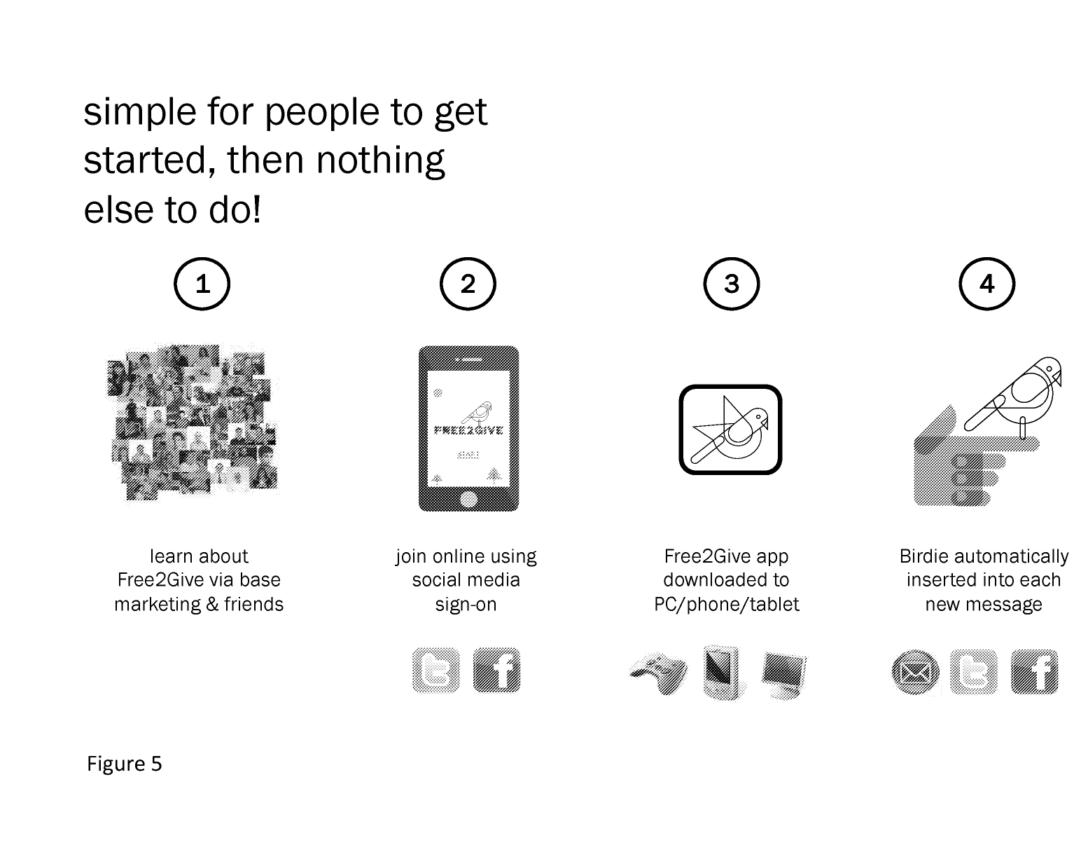

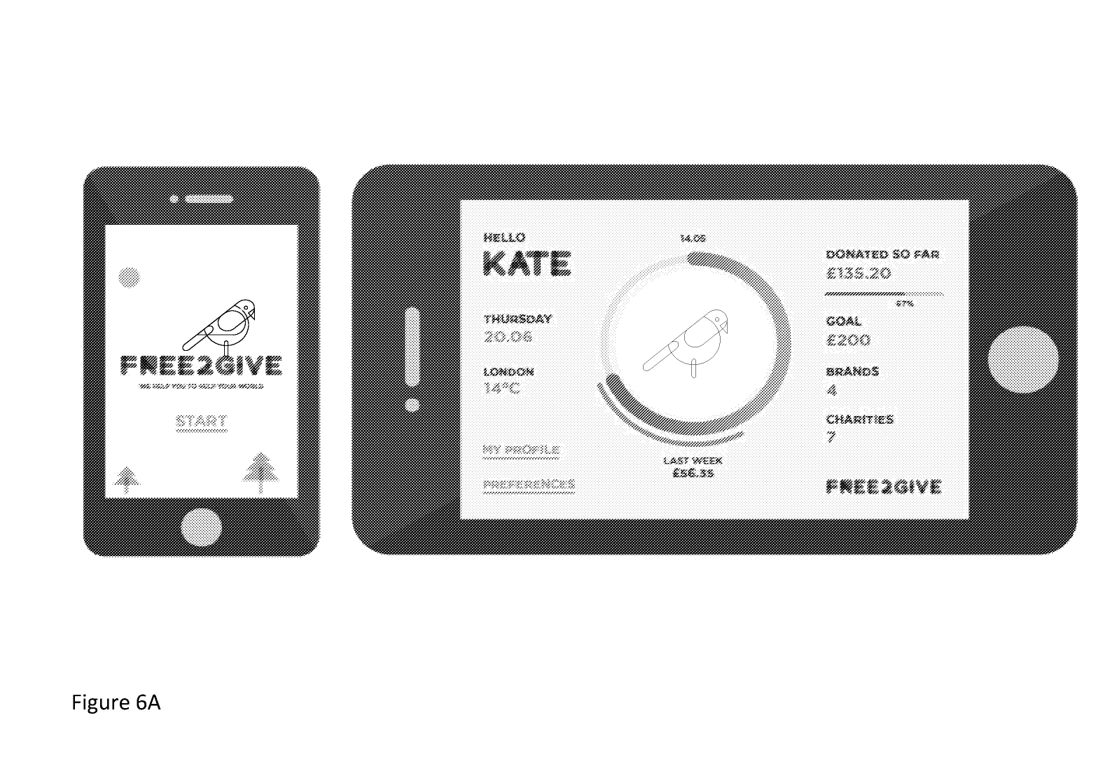

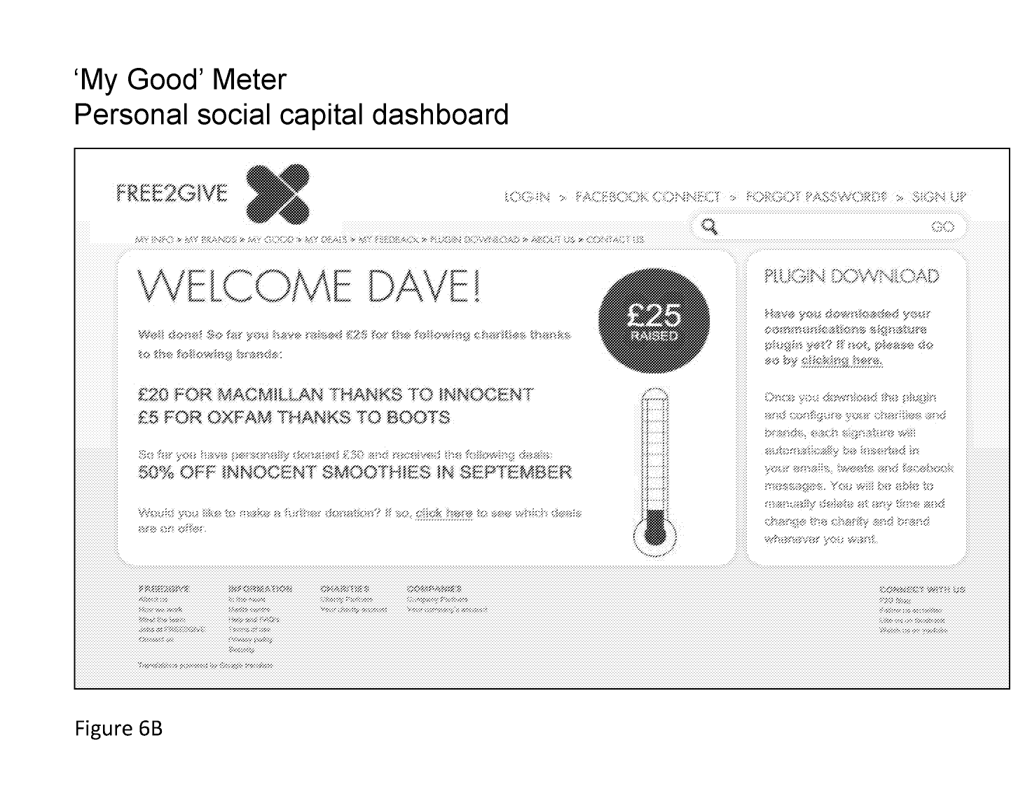

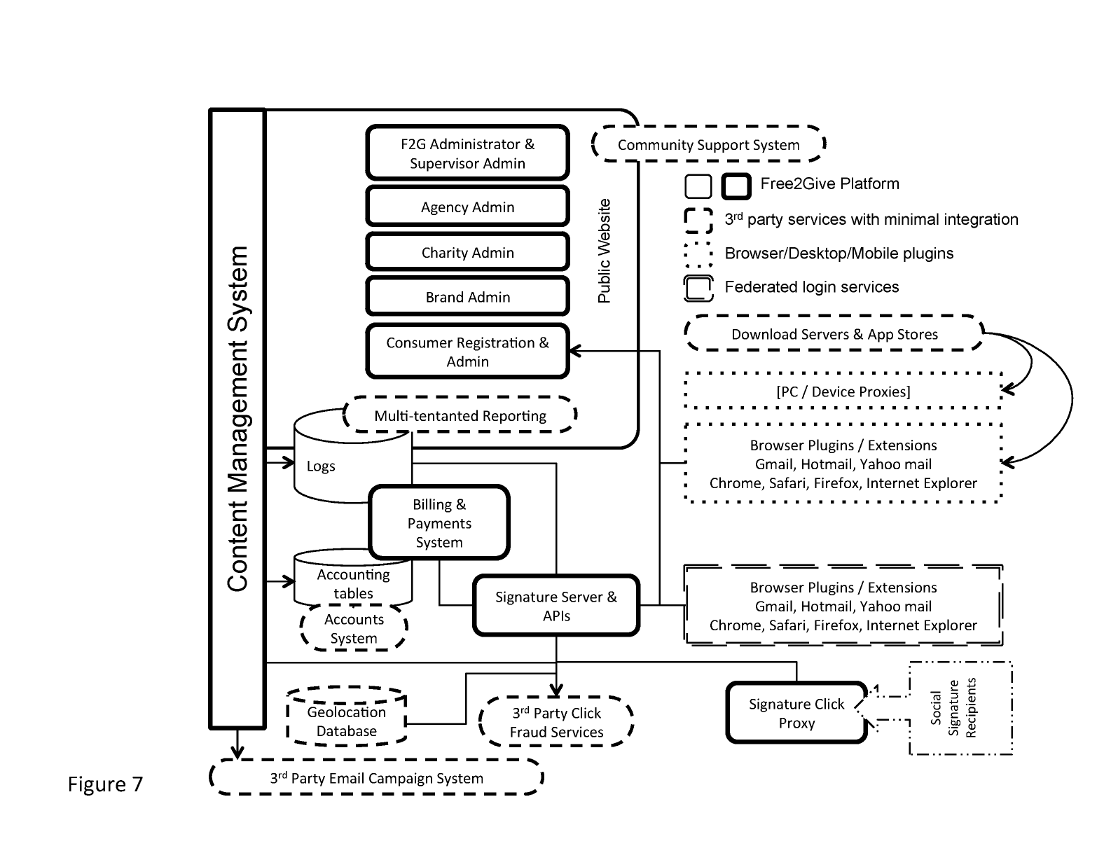

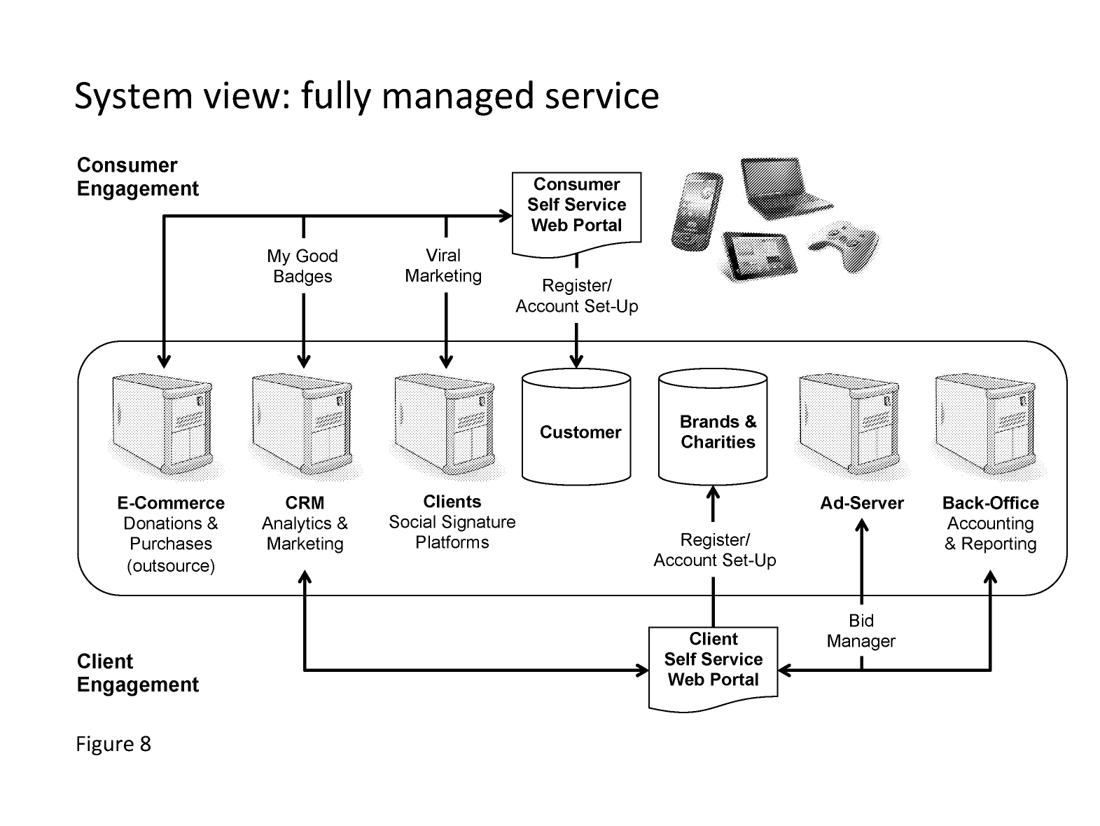

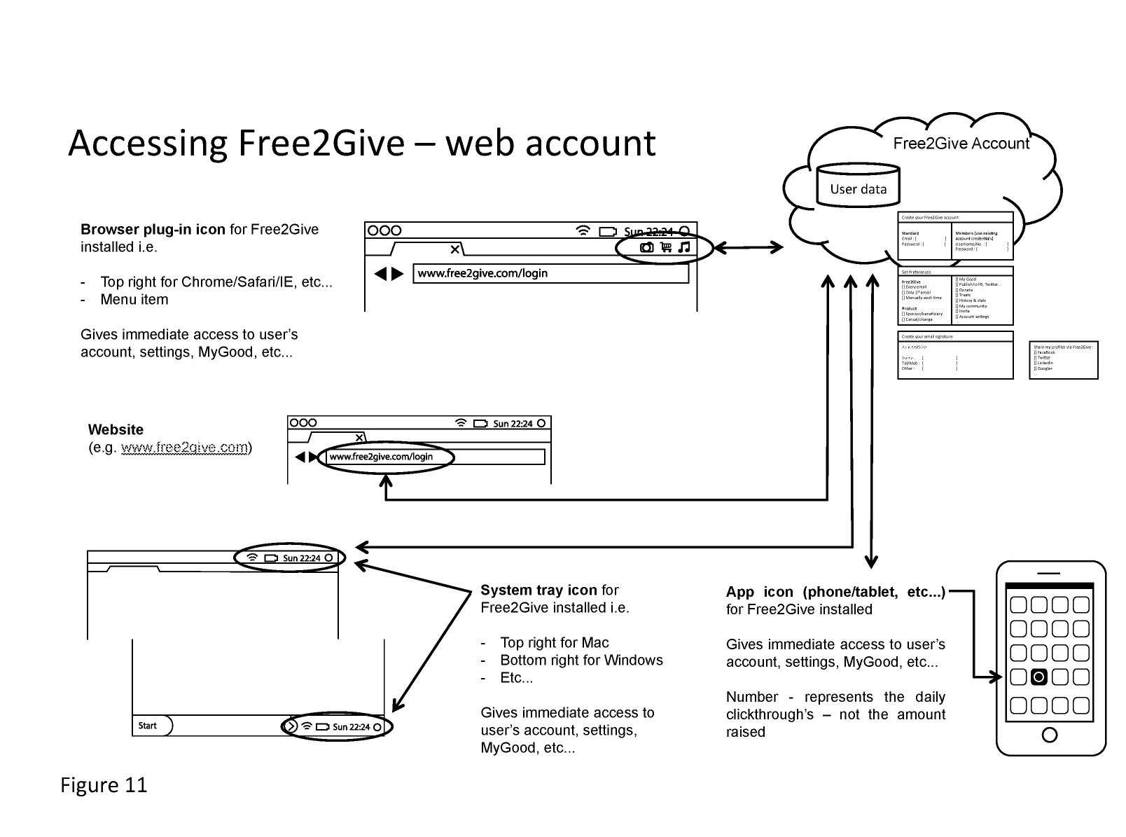

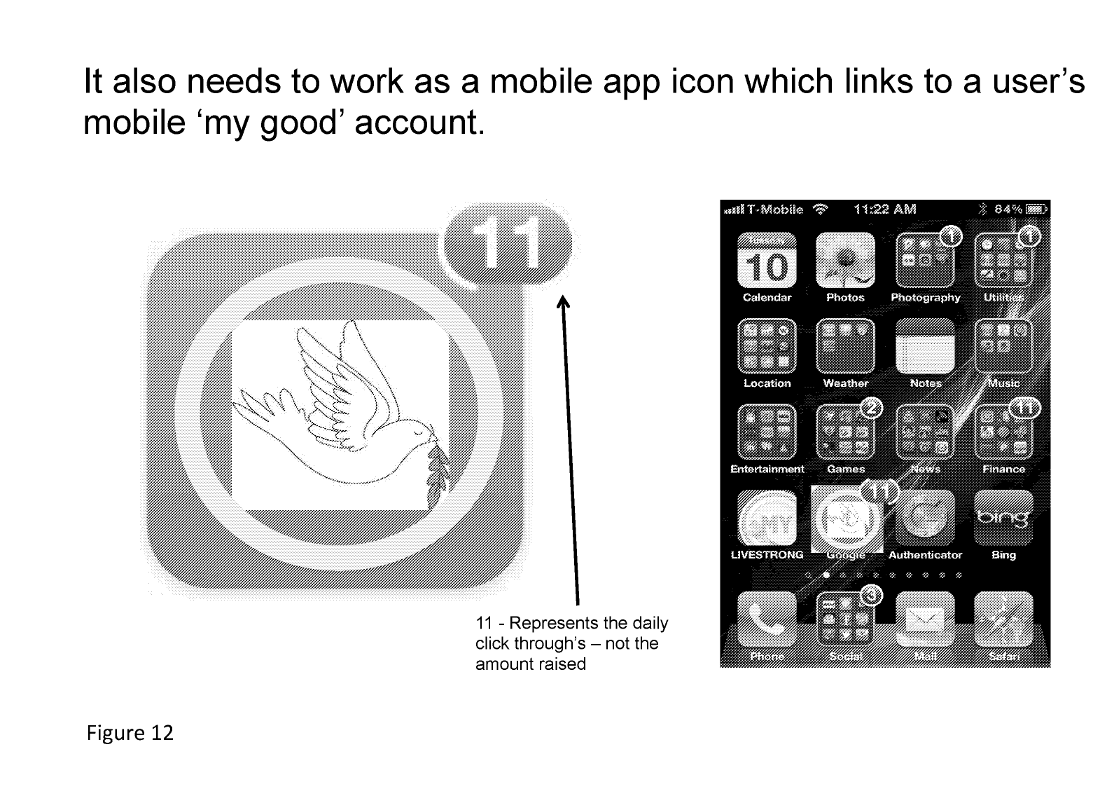

FIG. 11 is a schematic showing the User Journey—Accessing Free2Give™—web account. A browser plug-in icon for the installed Free2Give™ app is shown, for example in the top right for Chrome™/Safari™/IE™, etc, or as a menu item. This gives immediate access to the user's account, settings, MyGood (see FIG. 4 and FIG. 5) with the user's donation data, etc. A system tray icon can be shown also; conventionally, this is placed on the top right of the display for Macs™ and the bottom right for Windows™. Again, this gives immediate access to user's account, settings, MyGood landing page, etc. An App icon for Free2Give™ installed on the (for phone/tablet, etc. . . . ) also gives immediate access to the user's account, settings, MyGood landing page, etc. . . . Note that the number shown next to the Free2Give™ app icon (see FIG. 12) will typically represent the daily clickthrough's—not the amount raised.

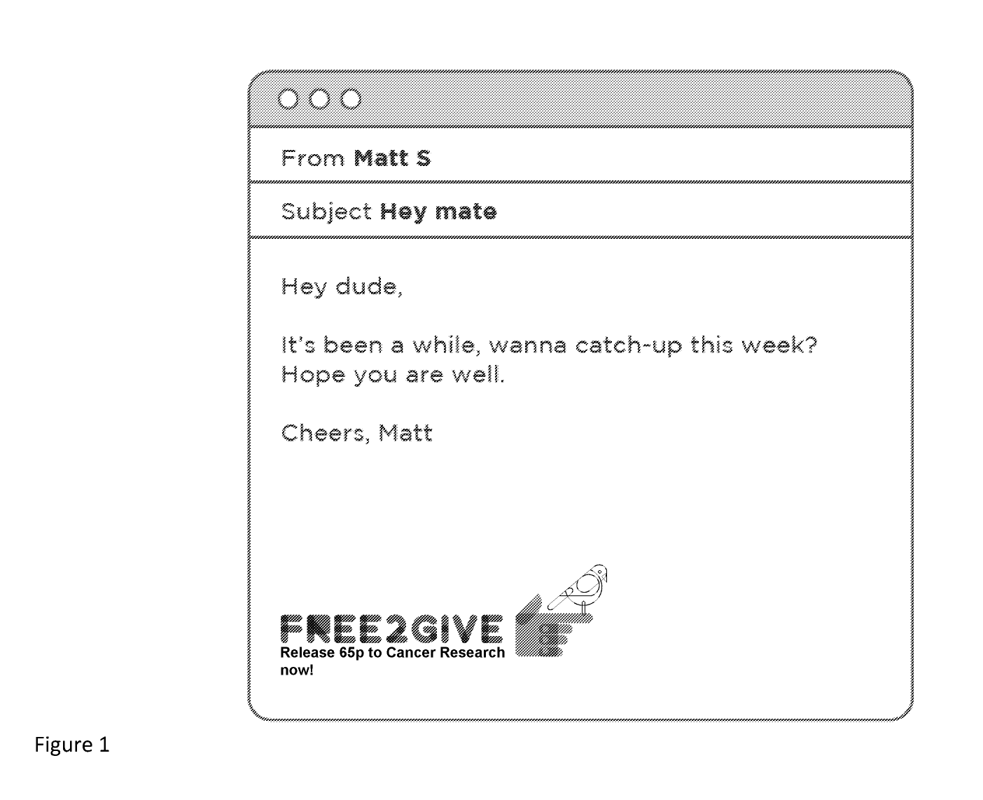

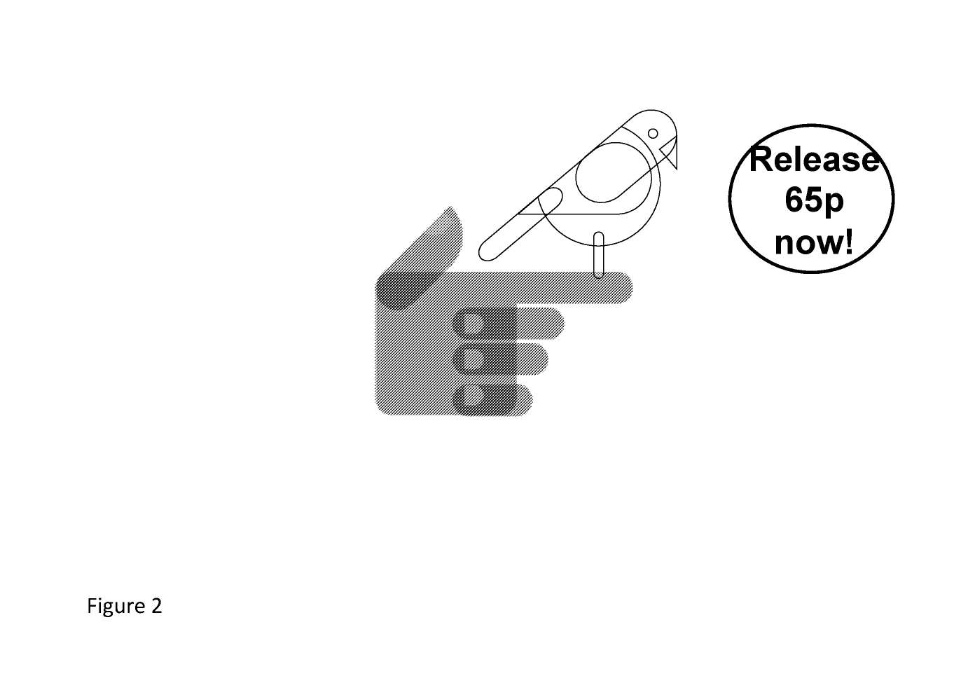

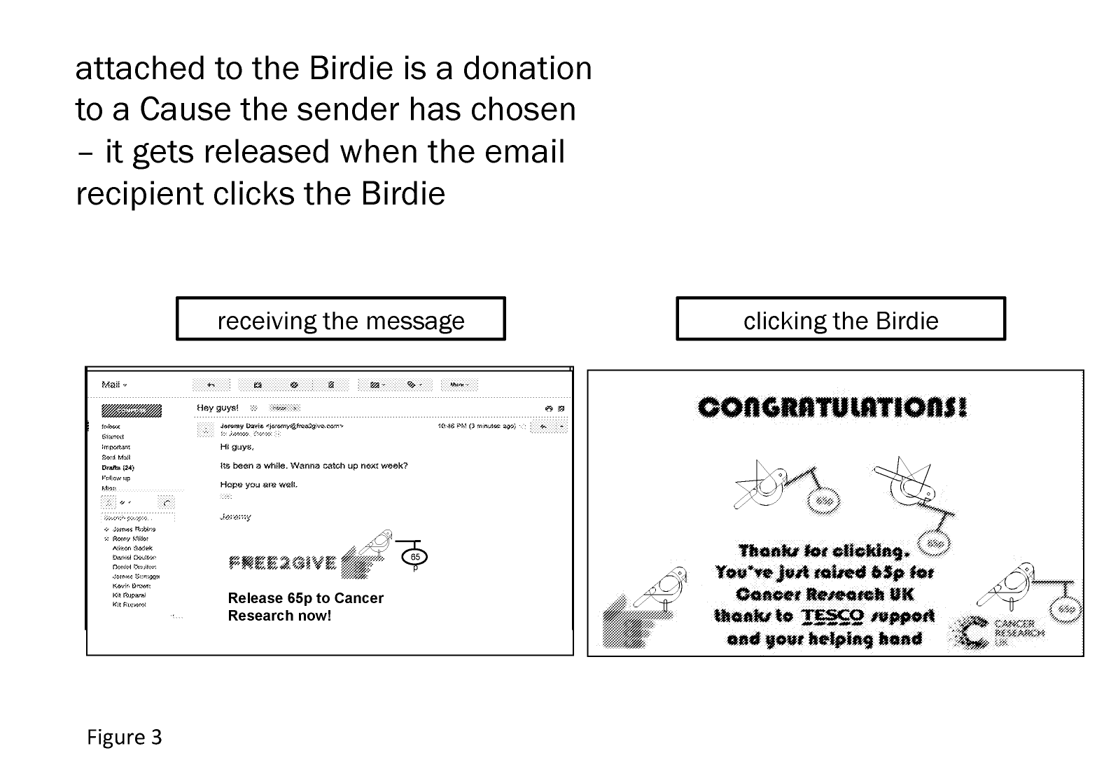

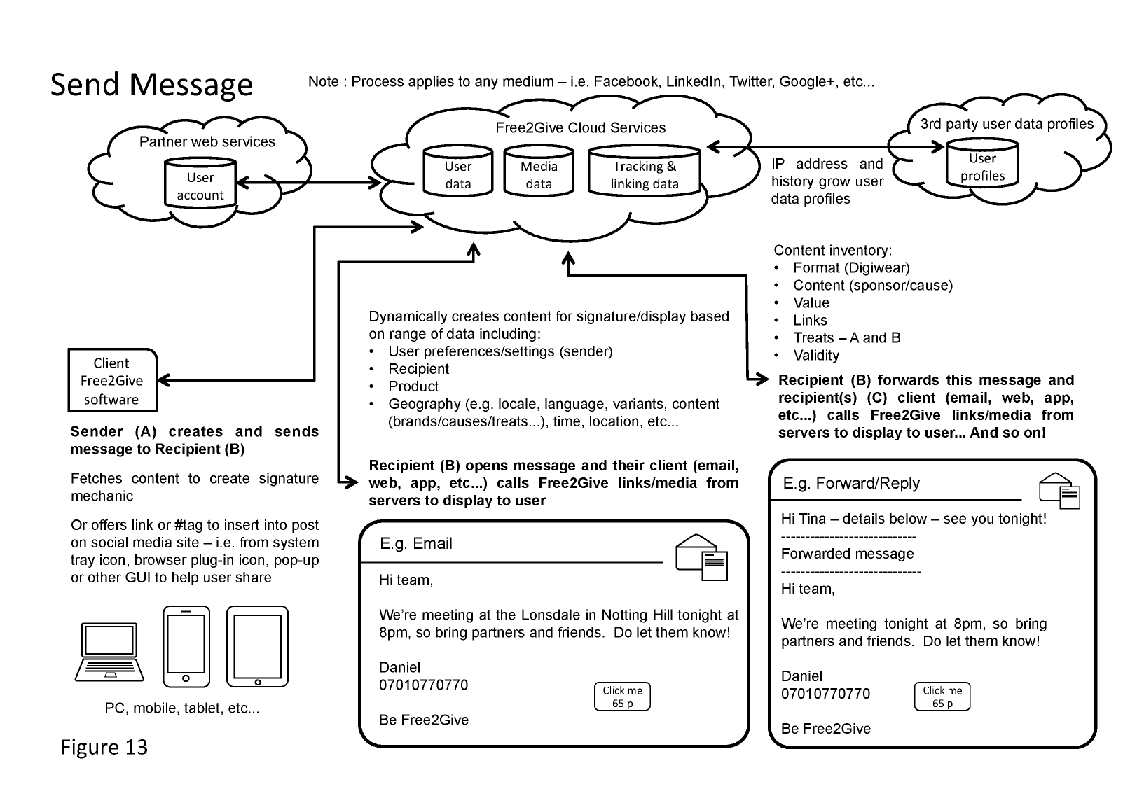

FIG. 13 is a schematic showing the User Journey—Send Message. The process is as follows:
Sender (A) creates message to Recipient (B)
Sender's device fetches content from the Free2Give™ server to create a signature mechanic (e.g. the bird Donation Mechanic shown in FIG. 1)
Free2Give™ cloud services platform dynamically creates content for the Donation Mechanic/display based on range of data including:
   User preferences/settings (sender)
   Recipient
   Product
   Geography (e.g. locale, language, variants, content (brands/causes/treats . . . ), time, location, etc.

Free2Give™ cloud services platform uses inventory that varies according to:
Format (e.g. Digiwear)
Content (sponsor/cause)
Value
Links
Treats—A and B
Validity

Free2Give™ cloud services platform may also offer links or #tags to insert into or post on social media sites; this functionality is accessible from the system tray icon, browser plug-in icon, pop-up or other GUI to help user share its Donation Mechanic.
Next, the Sender (A) sends the message to the Recipient (B)
Recipient (B) opens the message and their client (email, web, app, etc. . . . ) uses the Free2Give™ link or media in the message to call down a dynamically created Donation Mechanic from Free2Give™ servers in order to display to the recipient the ‘Click me, 65p’ Donation Mechanic in the message. This enables the Free2Give™ platform to dynamically create an appropriate Donation Mechanic depending on recipient variables, such as location, nature of recipient etc.
The recipient reads the message and forwards this message on, with the ‘Click me, 65p’ Donation Mechanic intact. Recipient(s) (C) client (email, web, app, etc. . . . ) calls the Free2Give™ links/media in order to display the Donation Mechanic to Recipient C and so on, forming a chain of advocacy for a Cause and a chain of donations to that Cause, linked with a chain of awareness for a Brand.

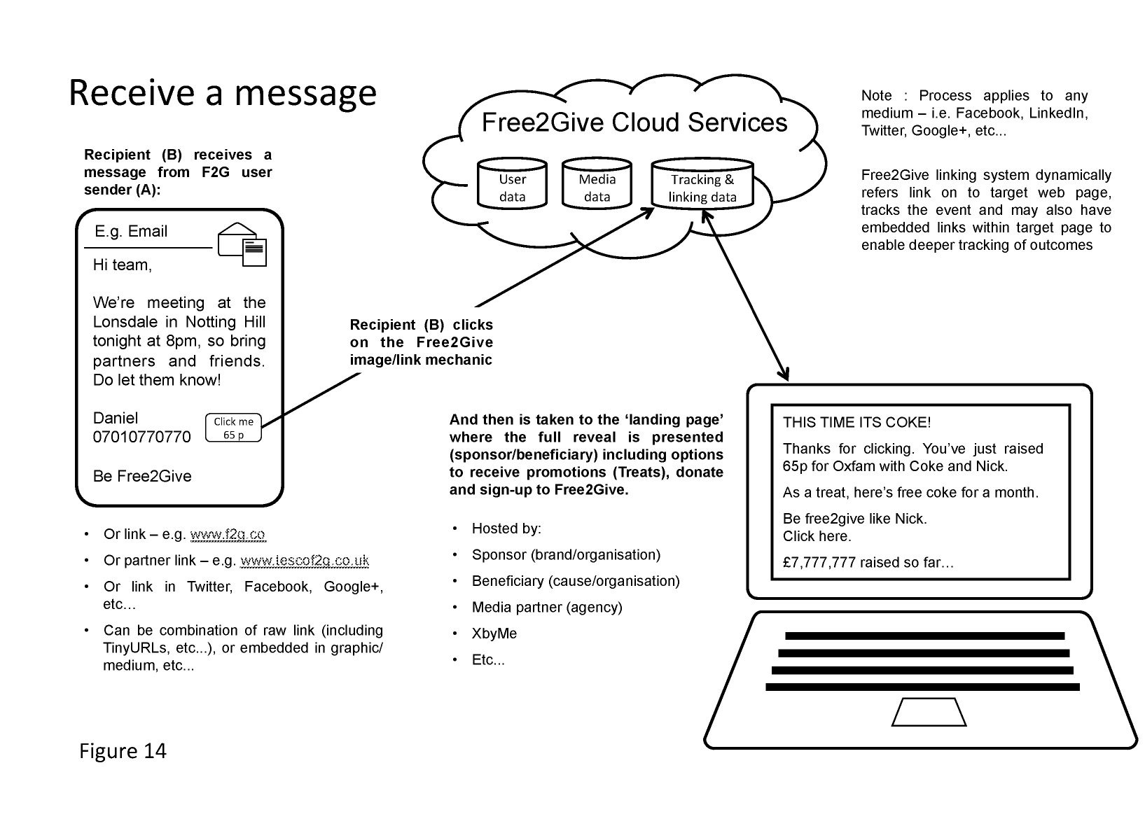

FIG. 14 is a schematic showing the User Journey—Receive a Message. The steps are:
Recipient (B) receives a message from Free2Give™ user sender (A)
Recipient (B) clicks on the Free2Give™ image/link mechanic
   Or link—e.g. www.f2g.co
   Or partner link—e.g. www.tescof2g.co.uk
   Or link in Twitter™, Facebook™, Google+™, etc. . . .
   Can be combination of raw link (including TinyURLs™, etc. . . . ), or embedded in graphic/medium, etc. . . .
And then is taken to a ‘landing page’ where the full reveal is presented (naming the Brand and Cause) and also including options to receive promotions (Treats), donate and sign-up to Free2Give™.
   Hosted by:
   Sponsor (Brand/organisation)
   Beneficiary (Cause/organisation)
   Media partner (agency)
Note: Process applies to any medium—i.e. Facebook™, LinkedIn™, Twitter™, Google+™, etc. . . .
Free2Give™ linking system dynamically refers link onto target web page, tracks the event and may also have embedded links within the target page to enable deeper tracking of outcomes.

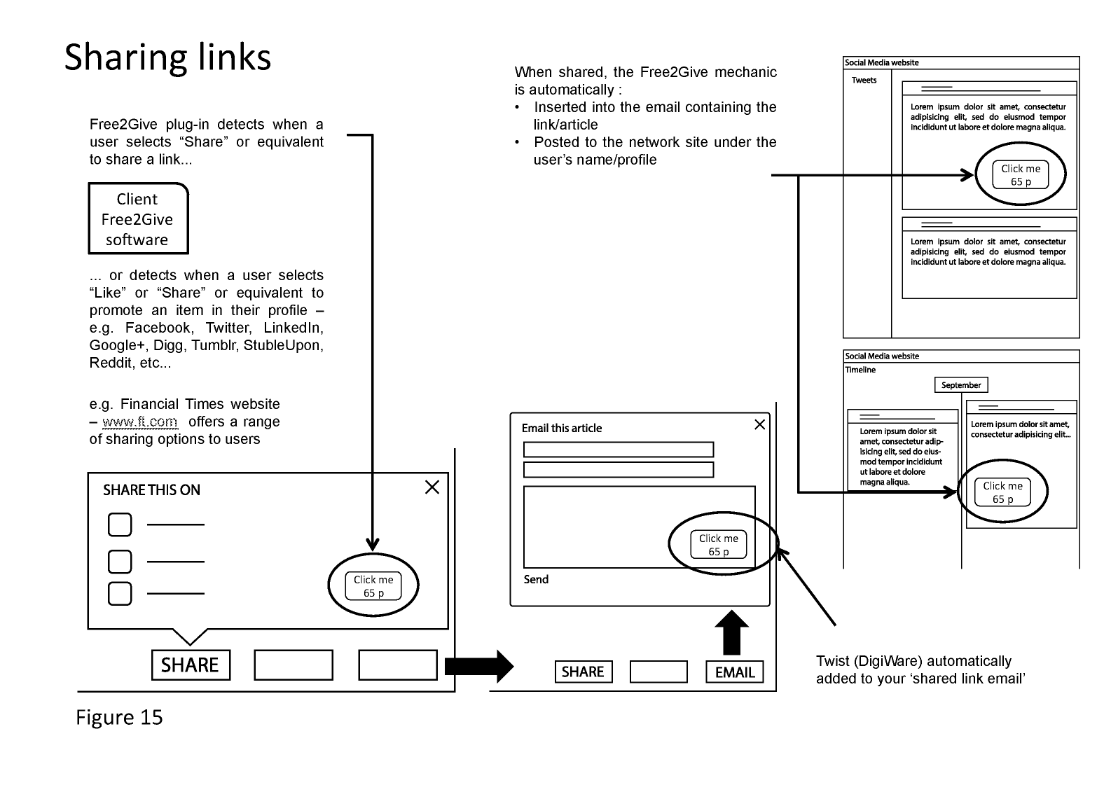

FIG. 15 is a schematic showing the User Journey—Sharing links. The Free2Give™ plug-in detects when a user selects “Share” or equivalent to share a link, . . . or detects when a user selects “Like” or “Share” or equivalent to promote an item in their profile—e.g. Facebook™, Twitter™, LinkedIn™, Google+™, Digg™, Tumblr™, StumbleUpon™, Reddit™, etc. When shared, the Free2Give™ ‘Click me, 65p’ Donation Mechanic or Donation Mechanic is automatically:
Inserted into the email containing the link/article
Posted to the network site under the user's name/profile
   3. Trading Presence for Things You Care about: The Social Capital Exchange

In the Prior Art section, we contrasted the positions of ordinary individuals, who may well believe that they never give enough to Causes they care about, the position of those Causes, who need more cash and more donors, but find it hard to do so, and the Brands, for whom consumer endorsement is very valuable but is very hard to receive in a trustworthy manner. We have seen in preceding sections how the Free2Give™ augmented messaging platform allows individuals to show their support for a Cause, not by donating directly to that Cause, but instead by sharing space in their messages, like email etc, with a Donation Mechanic. When that Donation Mechanic is clicked on by a recipient, it is made explicit to that recipient that a Brand has just paid money to a Cause that the sender believes in.

From the message sender's perspective, and to summarise what we have previously described in detail:
I choose a Cause close to my heart—regardless of my budget
And because I choose a Brand, or see a Brand giving, my emotional bond (premium) with them increases
   So we have users telling Brands where their true brand affinity lies when it comes to Causes close to their heart
So my relationship with my Cause is now purer
And if the Brand gives me something too, then we've created another new relationship
If I then show this to my community . . .
I'm sharing what I care about
Causes+Brands
My Donation Mechanic with a brand inside
As I want them to recognize ‘my good, I'm including my community in this equation. They are also intrinsically part of this—they're seeing ‘my good’ in action and are the value of sponsorship. The paid for eyeballs, clicks, interactions . . .
And they too can choose to be part of this and have their own ‘my good’

We will look now at ‘Sharing Models’. Conventionally, when we share, for example a posting on a social network site such as Facebook making a recommendation or a ‘Like’, then a third party (e.g. Facebook™) monetises the value of our content and the relationships we hold: an advertising system inserts adverts from the highest bidder alongside the content being shared. The third party is estimating what might be relevant to the viewer of the recommendation, and they control whom and what gets put in the messages, not you the user.

More specifically, sharing today is sharing with advertising networks and is untrusted. When I share content with my friends, colleagues or online acquaintances, I mostly do it through free, open systems, such as Facebook™, MSN™, Hotmail™, Gmail™, Twitter™, etc. . . . The deal is: we get to share through this system for free, but the system owner gets to monetise all our content and keep it all. So, when I share something with a friend, the value of that isn't exclusively ours. In fact, it's being sold by the system owner to the highest advertiser. So, whomever else rides along in my content is being injected by an anonymous 3^{rd} party. So, when we share, lots of what we also see comes from uninvited 3^{rd} parties. This doesn't feel like true sharing as whom gave them permission to be part of the transaction? What else do they know about me? Who gave them permission to eavesdrop our interaction? Do I truly trust the integrity of the whole content being shared—do I trust the sender who seems to attract all the wrong types of 3^{rd} party?

In the Free2Give™ augmented messaging system, the user is typically actively selecting sponsors or Brands to support the Causes the user cares about. The user now consciously trades its content and network for something it cares about. The user's network now knows that I've done this consciously and for a visible outcome. In fact, they get to benefit too—Treats, exchanges, credit, etc. . . . So, now the transaction is open, clear and trustworthy.

The user's perspective is now:
I'm in control of who rides along in my messages and how
I determine if I want to share this Donation Mechanic (or equivalent vehicle for sharing) or not
And I determine whom benefits from this trade—sponsor my messages in return for getting something we actually care about.

We summarise now the key features of how to share through Free2Give™:
Design your Donation Mechanic™
   Choose your Brand (sponsor) and Cause (beneficiary) and context
   Even select other formats of Donation Mechanic from the DigiWear™ range—DigiShoes, DigiGoggles, DigiTies, etc. . . .
Share it through a growing range of mediums
   And even share it when sharing other things—links, Likes, recommendations, etc. . . .
Determine whom the beneficiary is
   Range of new business models emerge
Trade your presence for things you care about
   Not just your digital presence, or access to your network
   But also your physical location
   And your mood, status, disposition, etc. . . .
   In fact, trade anything about yourself you're willing to share
Let context conditionally change how Free2Give™ behaves
   Because you've shared location, receive or share relevant (local) sponsors offering local Treats
   Just by wearing a certain digital apparel you can signal what you're available for
   Or setting base rules or statuses

In more detail:
I create a Donation Mechanic (or equivalent mechanic) by choosing my sponsor and the outcome (beneficiary)
I choose what I'm trading, conditions I'll trade, including:
   Presence in messages or any medium
   Location
   Mood and disposition—DigiWare™
And what I'm trading it for
   Outcome, currency, credit, points, vouchers, etc. . . .
The outcome (beneficiary) may be a 3^{rd} party (e.g. a cause) or myself, or my network
The sponsor can include a Treat (engagement offer) for both myself and any of my chosen recipients or a 3^{rd} party of my choosing (e.g. cause, publisher, reviewer, etc. . . . )
And what format I'm sharing this in—DigiWare™
   The bird Donation Mechanic is an initial format for ‘wearing’ your sponsorship—the first piece of apparel in DigiWare™
   DigiWare™ is in essence a range of designer apparel that you can choose to wear online to suit your style, mood, presence, medium, location, etc. . . .
   DigiWare™ is an open format that any 3^{rd} party can design to and share within the Free2Give™ system
I can now choose to share my personal Donation Mechanic with my network
I share my Donation Mechanic through any medium including
   Facebook™, eMail, Twitter™, LinkedIn™, Skype™, etc. . . .
Hence, it's something ‘X’ that I've created ‘by Me’ by configuring the sponsor, what I'm trading, whom benefits (sponsorship and Treat options) and how it looks (DigiWare™)
And the number of times (X) that I share (by) with others is the power of being (Me)

When designing the Donation Mechanic:

The user can set the beneficiary to any 3^{rd} party of its choosing—e.g.
Recipient
My network/group/community
Cause
Publisher
Reviewer
Company

The user can set the sponsor to any brand or entity of its choosing—e.g.
Commercial brand
Myself
Interested parties—friends, families, communities, etc. . . .
My company

It can share the Donation Mechanic through a wide range of mediums—even print, to create any outcome it wants. So the user can configure:
What it is trading—messages, presence, location, mood, disposition etc. . . .
Conditions or context for when I'll trade
What I'm trading it for—outcome, currency, credit, points, vouchers, etc. . . .
What format—select from a range of things to wear from DigiWare™ store
Whom benefits—sponsorship, treats, etc. . . .

The user can share it when it wants, and that sharing can be conditional or rules based. And the user determines who benefits to create outcomes the user cares about. For example:
User posts link in a Tweet
Recipient either clicks on the link, or uses built in ‘View’ option
Donation Mechanic is revealed within Twitter
User clicks on the Donation Mechanic and is taken to a ‘Reveal’ and also to the Brand or the Cause's website, depending on the exact design of the Donation Mechanic and what the recipient selects.
In Facebook™, a user posts a message and Donation Mechanic to its Wall or Timeline; a friend User clicks on the Donation Mechanic and is taken to ‘Reveal’ and the Brand's website, or the Cause's website, again depending on the exact design of the Donation Mechanic and what the recipient selects.

In this next section, we will look at some new models of sharing.

From the user's perspective:
Free2Give™ allows me to trade my location for something I care about
So, I might be out and about
   I might also choose to wear ‘DigiShoes’ Donation Mechanic I've selected from the DigiWare™ cupboard to signal my status
Now, my sponsors may change to be more relevant to my context
   E.g. from Apple™ to Caterpillar™, or Penguin Books™ to Starbucks™
   Or I'm out and it's lunch-time, so a local pub sponsors messages I receive, or share with others whom are local, and the Treat is a discount or special at the local pub
And if I share, or someone else shares a Donation Mechanic with me, and either one of us is out and about, this contextual switch may occur.
   Free2Give™ will know where we are—we've chosen to trade location
   Free2Give™ allows local businesses or relevant brands to appear as the Donation Mechanic sponsor
   We receive Treats from local businesses or relevant brands when we're out and about

In this next part, we will discuss sharing links. Many websites offer users a simple button to share a link to their site with others and use a range of mechanisms; these websites include: Like, Twitter™, Stumbleupon™, Reddit™, Delicious™, Digg™, Yahoo's™ meme, Tumblr™, Indiblogger™, Bloggers™, Dzone™, etc. The Free2Give™ platform auto-generates an email which the site sends on the user's behalf to its named recipient(s).

Free2Give™ can automatically add a link (to a Donation Mechanic/Treat) into the sharing mechanism. The recipient now gets a shared link from you (the sender) with an added Donation Mechanic that carries a Brand or sponsor and Treat for them. Websites can now advertise that by sharing them (their link) with your community, you can also share a Treat with recipients and do good (whomever the site sets the Donation Mechanic beneficiary to be). Or, you can choose to insert your own Donation Mechanic simply by sharing or pasting in your own Donation Mechanic (link). This helps drive traffic to their site and introduces a whole new monetisation mechanism: The sponsor may pay the site for being carried in their Shared Link mechanic and the users may further generate engagement revenue which is shared with the site.

Free2Give™ also includes a recommendation sharing function: Many sites, such as blogs, personal websites, and other publishing mechanisms suffer from weak monetisation potential. The best they get are ads that they sell on their site through 3^{rd} party ad networks. The most popular is via Google's advertising platform. Adverts are often ‘spam’ grade and have nothing to do with site, reader or recipient—just a volume/exposure game. However, visitors are often a niche of highly appreciative readers, which is why traffic is relatively low and doesn't generate much advertising revenue. So, by allowing me (as a visitor) to share this site's link along with my Donation Mechanic, I can share the benefit of my sponsorship (i.e. my Treat from the Brand) with the site. Now the site is receiving revenue ($) because people like me rate it and are prepared to share it. And sponsors will value this as I'm an advocate of this site and want it to benefit (just like a Cause). A new business model is created where individuals can create recommendation revenue for each other. Gone is the dependency on low rated, low value push advertising, replaced with ‘Here is my endorsement and my contribution (thanks to my chosen Brand or sponsor) to your site/business/presence’.

Sharing with the web site owner, itself a new business model, looks like this from the user's perspective:
I decide I want to share a particular web site with my network
I either use
   the web site's own shared link mechanism which connects to Free2Give™
   my Free2Give™ browser plug-in for sharing
   my Free2Give™ enabled apps—e.g. Twitter™, Facebook™, Email, etc. . . . On any device (desktop, laptop, pad, mobile phone, etc. . . . )
The Donation Mechanic is now going to
   share the link to this site
   be sponsored by a brand of my choice
The beneficiary is the web site owner—sponsorship and Treat—i.e. how much and with whom else, is all at my discretion
I can change my DigiWare™ Donation Mechanic appearance or apparel to suit the mood/site, etc. . . .
   E.g. I send my Designer Glasses version sponsored by Prada™, not my Wrist-band sponsored by Nike™

DigiWare™ Donation Mechanic is especially suitable for gifting. From the user's perspective:
Through Free2Give™, I can share Donation Mechanics with anyone I like
Donation Mechanics carry an optional Treat
So, I might be sitting at home when I receive a message (call) from a friend who is out in the rain, waiting for say a bus
   Or their message is showing they're wearing Digi-boots (from the DigiWare™ store), so I know this means they're out and about
I can now share a Treat with them either
   From one of my Brands or sponsors
   Or from my own credit with either one of the sponsors or my loyalty points
I send him a message with a free cup of coffee in it
   Perhaps from my Starbucks™ sponsor, my loyalty points or any other mechanism I have to acquire and spend credit with them
My friend can now go to the nearest coffee shop and redeem the Treat I sent them and enjoy waiting for the bus in a warm shop, not the cold rain!

For example, the user might receive a message from Peter that says ‘Dan—waiting for the bus so start without me . . . raining too!’. Dan goes into his Free2Give™ service and selects ‘gift’ and coffee
Starbucks may offer to pay for the coffee
Or I use my own Starbucks™ points
Or I buy/trade credit for a cup of coffee

Dan creates a message for Peter, reading ‘Here Peter—one for the road!’ and includes as a Donation Mechanic a mechanic that when selected reveals a voucher for a cup of coffee at Starbucks™; Dan walks into the nearest Starbucks and redeems it.

The DigiWear Donation Mechanic is an extendible format: DigiWear is a range of designer apparel which takes the initial Donation Mechanic format and creates new executions of the concept to better express how a user might want to be seen. 3^{rd} parties can design their own DigiWear and sell them if they choose from either their site or Free2Give™'s sites. E.g. Limited edition Stüssy™ apparel—£20 to own one of 1000 in series. A user now wears exclusive Stüssy sponsored DigiWear and selects causes or beneficiaries to go with it, unless Stüssy are only allowing certain causes or beneficiaries to ride along, e.g. ‘Wear DigiShoes’—to go on the footer of my messages; ‘DigiGoggles’—to go on the header of my messages, ‘DigiRings’—to go by my name.

So, by wearing a certain DigiWear item, I might be signaling my status/availability, etc., i.e. providing context about myself that can be used to conditionally change what happens in Free2Give™. If I come home, I might use the Free2Give™ app to flick my status to ‘slippers’.

Now, if I message anyone, I'll be wearing slippers which means I'm only interested in relaxing products/services—not business or technology. And if I'm about to message someone else who is a Free2Give™ user, the system will see what they're wearing and conditionally change what they receive from—for example, anyone based on what they're wearing or playing with—e.g. footballs, then I'm playing sports, so appropriate sponsors are sports brands. Or me as my worn status combined with their worn status creates a new set of contextual conditions. Or Free2Give™ user 1 is wearing glasses (to indicate searching) and Free2Give™ user 2 is wearing slippers (indicating at home relaxing) and a message from user 1 to user 2 could mean the best brand type is a local bookshop or beauty treatment salon.

We will now review the accounts for the main actors:

### Brands (Sponsors)

Follows standard digital advertising process (e.g. Google™ Ad Sense)
Credit in Free2Give™ Media account (e.g. £50 k)
Credit drawn down as twist (or other Free2Give™ products) served or engagement generated
Account topped-up when credit at zero
Certain large trusted accounts may have an account and pay on an invoice

### Beneficiaries (Causes)

Register an account to be listed
Credit is accumulated as twists (or other Free2Give™ products) carrying their logo or twists they're beneficiaries of, are served or engagement generated
Or receive credit as users share their credit with them—i.e. set them to be the beneficiary even if not listed explicitly in their Donation Mechanic (or other Free2Give™ products)
Beneficiaries accounts are settled at periodic intervals, either monthly or on a specific event
Free2Give™ pays them directly on standard payment terms (e.g. 30 day payable)

### Recipients: Treats

Receive treats (offers from Brands) directly in messages to them
Redeem them directly from the offerer (sponsor)
If they too become a Free2Give™ account holder, they may also receive Treats in their Free2Give™ account
Can also pay (donate) a specific amount (one-off or regularly) directly to the Cause (beneficiary) through Free2Give™

### Users

Register an account through Free2Give™
Receive treats (offers from sponsors) in their ‘inbox’ at Free2Give™ (‘My Good’ page within Free2Give™)
Can also pay (donate) a specific amount (one-off or regularly) directly to the Cause(s) (beneficiary) through Free2Give™
If redemption of any credit or offer, then taken directly to brand's site/point of redemption to exchange
If cash, then either paid into Free2Give™ by sponsor and then credited to user's account, or paid directly to user's nominated account by sponsor
Credit—e.g. loyalty points, discounts, etc. . . . Redeemed directly with issuers
Can also give their credit to others directly—either account-to-account, or for non-users send them a Donation Mechanic (or equivalent) bearing their gift (treat)
Can also change the beneficiary to any other registered party
Or ultimately trade credit with other users through Free2Give™

Free2Give™ allows users to:
Vary the rate at which they share any sponsorship they receive between 3^{rd} parties and themselves (in Free2Give™, it's set to 100% to causes)
Change whom the beneficiary is (not just a cause, but a 3^{rd} party or even themselves)
Share your credit with others—set them as beneficiary
Gift your credit with others (e.g. gift your Starbuck™ points to someone)
Trade your credit with others—i.e. trade air miles for Nectar™ points

Free2Give™ enables new products and models to operate so that as a user, you can trade your presence for something you care about (currency) beyond a cause. Possible products include:
Free2Get—get offers, discounts, etc. . . . from brands
Free2Go—get loyalty points, air miles, credit, etc. . . . from brands
Free2Raise—turn you Donation Mechanic into a way of raising money for an event your undertaking—e.g. a charity run—in which beneficiary is your fund for a cause, sponsors match recipients donations and/or provide other treats or incentives to encourage engagement with your event.
White-label versions of Free2Give™—namely where the sponsor and cause(s) are fixed so that a brand can market this to their base as the exclusive sponsor
   E.g. Tesco™ markets its unique Donation Mechanic which supports their nominated causes and markets to all Tesco™ Clubcard holders to carry their Donation Mechanic

The Free2Give™ API can be used to open the Free2Give™ platform up:

### B2C:

3^{rd} parties to build their own products
Distribute Free2Give™ products
Create new ways of interacting and exchanging through Free2Give™
Apps, Web apps, products, services

### B2B:

And with Free2Give™, connection to other systems or exchanges enabling new features and products within Free2Give™.

### 4. Product Requirements

This Section will define the Free2Give™ value proposition and the key features of the Free2Give™ service. Sections covered:
Value Proposition
Launch Product: FREE2GIVE™
CRM
Rating & Billing
Reporting & Analysis
Provisioning

### Value Proposition

This is a new service that will release the social capital built up by people and let them trade it for monetary value. The value proposition is schematically shown at FIG. 42.

### Social Capital Exchange™

XbyMe™ has created the world's first exchange that lets people trade their social capital—putting people in control of their content and how it is monetised.

Powered by our Next Generation Marketing & Media Platform, we plug in Brands and Media to take the universally accepted digital advertising ecosystem (£42 bn in 2010) and make it relevant for messaging: email (over 168 m messages/per minute), Twitter and Facebook.

The latent trust people build up through interactions with their personal digital network is immense. We unlock this by empowering people to convert this value into regular income for the things they care about—we call this Social Profit™. Facebook™ ‘Like’ and Twitter™ ‘Sponsored Stories’ push Brands to followers without any real personal context and so diluting their impact, and of course, they also keep all the advertising money generated from their customers' activity!

In contrast, Brands are pulled by subscribers via the FREE2GIVE™ service, instantly creating highly visible endorsement to their social circle.

Uniquely, we let our customers pass proceeds from Brands sponsoring their email and Tweets to the Cause of their choice.

Once a person registers with FREE2GIVE™, an app is downloaded to their computer/device that will insert DigiWear in their messages. Consumers can freely select their favourite Causes and which Brands they want to sponsor their messages. By accessing the preferences section of their account via computer or a dedicated mobile/tablet app, subscribers can see how much they have raised and change/automate the Cause/Brand selection.
My messages sponsored by the brands I choose, for causes I love!
Inclusive: my good shared with everyone in my community
Effortless: by simply viewing or clicking I am doing good!
Sponsoring brand will have ‘special offer’ for participants

### Account Set Up

| Ref. | Feature | Requirement |
|---|---|---|
| 1.1 | Sign-Up | Consumer clicks on URL to visit sign-up page |
| 1.1.1 | Profile | Mandatory Data: |
| | | (i) Name (Title, First, Surname) |
| | | (ii) Year Born (pull down list: 1930 to current year) |
| | | (iii) Country (pull down list) |
| | | (iv) Postcode/ZipCode (free field) |
| | | (v) Status (working, student, other) |
| | | (vi) Email Address (check validity of submission) |
| 1.1.2 | | Opt-Out Data: |
| | | Text in message headers can be viewed & analysed to allow real-time |
| | | view & building of customer profile |
| 1.1.3 | | Discretionary Data: |
| | | Submit the following alert - 14 days after registration. |
| | | “If you provide us with additional details, more money can be generated |
| | | for your good causes. We will not share this or any other data with |
| | | anyone” |
| | | (vii) Residential Status (own, rent, other) |
| | | (viii) Marital Status (single, married) |
| | | (ix) Car Owner (yes/no) |
| | | (x) Overseas Travel (under 2 trips/year, over 2 trips/year) |
| 1.1.4 | | Consumer is prompted to provide a user name & password for their |
| | | account. System should auto set user name as email address |
| 1.1.5 | | Customer must agree to the Terms of Service before account request is |
| | | submitted to the system |
| 1.1.6 | | Confirmation email sent to consumer to activate account |
| 1.1.7 | | Unique code is allocated to each new successful subscriber to |
| | | FREE2GIVE ™: |
| | | A/B/C |
| | | A = Country Code: UK = 1, US = 2, then allocate codes to each country |
| | | alphabetically |
| | | B = Sub Number: 000000001 ascending |
| | | C = Active Bearers: allocate two-letter code to each enabled platform for |
| | | subscriber |
| | | For instance, user in US, connected to Gmail & Twitter |
| | | 1/000143861/GM/TW |
| 1.2 | Access | Subscriber should be able to access subscription page on Internet |
| | | enabled devices |
| 1.2.1 | | Via all major browsers on PC, tablet, TV & gaming consoles |
| 1.2.2 | | Subscriber should be able to sign up via a mobile app: Android ™, |
| | | Apple ™ (iPhone ™ & iPad ™), RIM ™, Windows ™ |
| 1.2.3 | | URL should be provided to participating Causes & Charities to provide |
| | | click through from their sites |
| 1.2.4 | | Consumer is asked to complete word verification box to avoid |
| | | computer based sign-up |
| 1.3 | Platforms | FREE2GIVE ™ should be supported on major messaging platforms. |
| | | Consumer must select at least one, but can select many |
| 1.3.1 | | Gmail ™ (Google ™) |
| | | Hotmail ™ (Microsoft ™) |
| | | Yahoo Mail (Yahoo ™) |
| | | AOL Mail (AOL ™) |
| | | Facebook Wall Updates (Facebook ™) |
| | | Microsoft Exchange ™ |
| 1.3.2 | | Tweets (Twitter ™) |
| | | Windows Live Messenger ™ (Microsoft ™) |
| | | Skype Messaging ™ (Skype ™) |
| | | Blackberry Email & Messenger ™ (RIM ™) |
| 1.3.3 | | SMS |
| 1.4 | Client | Consumer is prompted with the correct client download version for |
| | | their device. |
| 1.4.1 | | Operating Systems to be supported: |
| | | Microsoft Windows ™: 95 onwards |
| | | MAC ™: (x) onwards |
| | | Linux ™ |
| 1.4.2 | | Browsers to be supported: |
| | | Internet Explorer ™ |
| | | Safari ™ |
| | | Firefox ™ |
| | | Chrome ™ |
| | | Opera ™ |
| 1.4.3 | | Successful installation is confirmed to the user & sample mail is |
| | | automatically created to show consumer |

### Setting Preferences

Consumers can select either a Brand and/or Cause, or leave to random selection. A further case is designated when either the Brand or Cause is not available for selection, by with consumer or system.

| | Brand | Cause |
|---|---|---|
| Case 1 | Selected | Selected |
| Case 2 | Selected | Random |
| Case 3 | Random | Selected |
| Case 4 | Random | Random |

| | |
|---|---|
| Case 5 | Not Available |

| Ref. | Feature | Requirement |
|---|---|---|
| 2.1 | Brand | Brand is allocated to message |
| 2.1.1 | Selection | Case 1 & 2: Consumer can select available Brand from a drop down list |
| | | of active Brands |
| 2.1.2 | | Case 3 & 4: Consumer can select ‘Random’ & the system will choose a |
| | | Brand based on the closest match between the brand target customer & |
| | | consumer profile |
| 2.1.3 | | The same Brand is allocated to each active bearer associated with the |
| | | consumer identity |
| 2.1.4 | | Case 1 & 2: Brand is allocated for a period of 30 days. Consumer will |
| | | then be prompted to select another/renew |
| 2.1.5 | | Case 3 & 4: Brand will be rotated among the top 5 ranked Brands on a |
| | | daily basis |
| 2.1.6 | | Brands are ranked by the CPR rate they are currently paying. Highest rate |
| | | at the top. If rates are equal, then list alphabetically |
| 2.1.7 | | Case 5: System administration facility to block brand from being matched |
| | | with a specific charity/class of charities. Brand will not appear in |
| | | selection list or for random selection |
| 2.1.8 | | Case 5: Facility for consumer to propose a Brand that isn’t participating, |
| | | creating reporting flag to marketing dept. |
| 2.1.9 | | Target customer profile allocated to each participating Brand. Allocate |
| | | weighting & relevance score to each parameter |
| 2.1.10 | | Brands have the facility to bid for insertion in cases 3 & 4 |
| 2.1.11 | | Case 5: if Brand does not have sufficient funds in account or is |
| | | delinquent in payment of invoice |
| 2.2 | Cause | Brand is allocated to message |
| 2.2.1 | Selection | Case 1 & 3: Consumer can select available Cause from a drop down list |
| | | of active Causes. |
| 2.2.2 | | Case 2 & 4: Consumer can select ‘Random’ & the system will choose a |
| | | Cause based on the closest match between the Cause target customer & |
| | | consumer profile |
| 2.2.3 | | The same Cause is allocated to each active bearer associated with the |
| | | consumer identity |
| 2.2.4 | | Case 1 & 3: Cause is allocated for a period of 30 days. Consumer will |
| | | then be prompted to select another/renew |
| 2.2.5 | | Case 2 & 4: Cause will be rotated on a random basis based on the closest |
| | | matches to the consumer profile |
| 2.2.6 | | Case 5: System administration facility to block Cause from being matched |
| | | with a specific Brand. Brand will not appear in selection list or for |
| | | random selection. User should be asked to “this Cause can not be |
| | | allocated to this Brand, please select another” if Cause is not available. |
| 2.2.7 | | Case 5: Facility for consumer to propose a Cause that isn’t participating, |
| | | creating reporting flag to marketing dept. |
| 2.3.8 | | Target customer profile allocated to each participating Cause. Allocate |
| | | weighting & relevance score to each parameter |

### Insert Donation Mechanic

The Donation Mechanic—DigiWear—is the key component of the experiences, linking Brands with Causes and indicating to the consumer who is the sponsor and who is the recipient of funds being donated by the consumer.

| Ref. | Feature | Requirement |
|---|---|---|
| 3.1 | Ad Serve | Brand & Cause images are held in an Ad-Server |
| 3.1.1 | Configure | Supported Formats |
| | | Standard image banners (GIF, PNG, JPG, & BMP files) |
| | | Flash/SWF |
| | | Text links ads |
| | | Rich-media & HTML ads |
| 3.1.2 | | Links into other Ad-Servers |
| | | AdSense ™, Double-Click ™, Atlas ™ & other leading providers |
| 3.1.3 | | Facility to enter the ad URL and its dimensions, generating the required |
| | | HTML code to display rich-media |
| 3.1.4 | | Support creative can be of any dimension. This includes all standard |
| | | dimensions & custom ad sizes. |
| | | IAB web ad sizes include 468 × 60, 728 × 90, 160 × 600, 120 × 600, |
| | | 120 × 300, 300 × 250. |
| | | MMA mobile ad dimensions include 300 × 50, 300 × 75, 216 × 36, |
| | | 216 × 54, 168 × 28, 168 × 42, 120 × 20, 120 × 30. |
| 3.1.5 | Optimise | Facility to run multiple optimizers in sequence. The standard |
| | | optimization path is to first maximize revenue, then conversion ratios |
| | | are considered and CTR’s will be considered last. |
| | | Evaluate ad performance in near real-time, every 5-10 minutes. Break ad |
| | | pool into 3 groups: good performance, poor performance and average |
| | | performance. |
| | | The good performing ad(s) get higher prioritisation & the opposite |
| | | situation happens to the poor performing ad(s). |
| 3.1.6 | Serve | Two types of rotation: |
| | Code | (i) Rotate ads based on a defined time or order |
| | | (ii) Serve a specific ad |
| | | Ads should refresh based on defined parameters: |
| | | (i) Customers Preferences |
| | | (ii) Time, e.g. month |
| | | (iii) Value of Ad |
| | | Each ad should have a unique spot number. |
| 3.1.7 | Targeting | For cases 3 & 4, ad will be served based on matching profile data & if |
| | | available, key word analytics from message headers |
| 3.1.8 | Tracking | Counting Impressions |
| | | One impression should be recorded for each originating message, with |
| | | the option to also include the number of recipients as the count for |
| | | impressions. |
| | | Counting Clicks |
| | | When a person (originator or recipient) clicks on an ad, a unique |
| | | tracking URL will record the click details and redirects the visitor to the |
| | | final destination URL |
| 3.1.9 | Reporting | Activity |
| | | Total Ad Impressions |
| | | Total Ad Clicks |
| | | Above by Brand/Advert |
| | | Above by Cause |
| | | Report Frequency |
| | | Hourly |
| | | Daily |
| | | Weekly |
| | | Monthly |
| | | Historical |
| | | Defined Period |
| 3.2 | Insertion | Donation Mechanic is inserted into message |
| 3.2.1 | | Brand & Cause are connected based on preferences & rules |
| 3.2.2 | | Donation Mechanic is inserted into message body when the user |
| | | commences composition of the message |
| 3.2.3 | | Message send activates impression count |

### Landing Page

The facility should be available for existing customers to view the money they have raised for causes and together with un-registered users, brand offers.

| Ref. | Feature | Requirement |
|---|---|---|
| 3.4 | | Primary entry page into the FREE2GIVE ™ service for existing & |
| | | unregistered customers |
| 3.4.1 | Look & | Page should contain the following information: |
| | Feel | (i) Brand offers “treats’ available to subscribers |
| | | (ii) ‘My Good’ login-page |
| | | (iii) Link to sign-up page |
| | | (iv) Count of total messages sent with Donation Mechanic |
| | | (v) Count of total money raised for good causes |
| 3.4.2 | My | Personalised page, accessible with login details. The following |
| | Good | information should be displayed |
| | | (i) Total value raised by subscriber for good causes |
| | | (ii) Value raised by subscriber for each good cause |
| | | (iii) Brands offers ‘treats’ - personalised |
| | | (iv) Hints to increase value of donations: |
| | | Provide additional Personal Data |
| | | Invite friends to participate |
| | | Switch on email header analysis (if opted-out) |
| | | Select Brands offering high ad rates |
| | | (v) Edit settings for Brand & Cause selection |
| 3.4.3 | Treats | Brands will be required to provide a monthly offer for all |
| | | FREE2GIVE ™ subscribers & the option to provide more personalised |
| | | offers for specific users. |
| | | Each Treat should be given a 30-day life. The current offer will remain |
| | | until replaced. |
| | | Marketing Department should have the following alerts: |
| | | 10 days before expiry - “Treat for <brand> due to expire in 10 days |
| | | 1 days before expiry - “Treat for <brand> due to expire in 1 day” |
| | | Daily after expiry - “Treat for <brand> has expired!” |
| | | Facility to resubmit Treat for another 30-days |
| 3.4.4 | Donation | Facility for subscriber to make a donation directly to Cause: Credit |
| | | Card/Debit Card/Pay Pal ™ |

### CRM

Providing support for all stakeholders is a key element of the value proposition; for consumers, Brands and Causes. Further, customer relationship management should actively seek to encourage additional users in a viral fashion.

| Ref. | Feature | Requirement |
|---|---|---|
| 4.1 | Increase | Introduce features to increase service participation |
| | Subscribers | |
| 4.1.1 | Friend Get | Submit the following alert - 30 days after registration. |
| | Friend | “Why not get your friends on email & Facebook ™ give freely” |
| 4.1.1 | | Auto fill from email contact list. Opt-in all contacts, with facility for |
| | | user to deregister individual contacts |
| 4.1.2 | | Auto fill from Facebook contact list. Opt-in all contacts, with facility for |
| | | user to deregister individual contacts |
| 4.1.3 | | Auto fill from mobile address book. Opt-in all contacts, with facility for |
| | | user to deregister individual contacts |
| 4.2 | Subscriber | Web based tools to provide low-cost support |
| 4.2.1 | Support | Posted on FREE2GIVE ™ web site: |
| | | User Guides |
| | | Frequently Asked Questions |
| | | On-Line User Forum (moderated) |
| 4.2.2 | | Make it easy for people to know how much they have given to Causes |
| | | My Good Monitor in Landing Page |
| 4.2.3 | | Make it easy for people to know how much they have given to Causes |
| | | My Good Monitor Mobile App: |
| | | i-Phone ™/i-Pad ™ (all models) |
| | | Android ™ (all models) |
| | | Windows Mobile ™ (v7 onwards) |
| 4.2.4 | | Terms of Service - tbc |
| 4.3 | Brand | Web based tools to provide low-cost support |
| 4.3.1 | Support | Activate New Account: |
| | | (i) Contact Name |
| | | (ii) Office Address |
| | | (iii) Telephone Number |
| | | (iv) Email Address |
| | | (v) User Name (email address default) & password |
| 4.3.2 | | Advertising funds account: |
| | | (i) Invoice |
| | | (ii) Recharge - Credit/Debit Card or PayPal ™ |
| 4.4 | Cause | Web based tools to provide low-cost support |
| 4.4.1 | Support | Activate New Account: |
| | | (i) Contact Name |
| | | (ii) Office Address |
| | | (iii) Telephone Number |
| | | (iv) Email Address |
| | | (v) User Name (email address default) & password |
| | | (vi) Bank Details |
| 4.4.2 | | Features |
| | | (i) Upload charity logo - TIFF/JPEG |
| | | (ii) Value of money raised to date |
| | | (iii) Historical monthly payments |
| 4.4.3 | | Marketing tips, e.g. email blast, web banners etc |

### Rating & Billing

Monetisation of FREE2GIVE™ will necessitate introducing a variation of globally accepted Google-type digital advertising model. In addition, the facility to track and collect funds should be a high priority from launch.

| Ref. | Feature | Requirement |
|---|---|---|
| 5.1 | Charging | Commercial framework to support prevailing charging |
| | Models | methodology for interactive advertising |
| 5.1.1 | | (i) Monthly Fee (unlimited impressions) |
| | | (ii) CPM - Cost per 1,000 impressions |
| | | (iii) CPC - Cost Per Click |
| | | One or combination of fee models can be in place at a specific |
| | | point in time |
| 5.2 | Rating | Introduce features to maximise revenue |
| 5.2.1 | | System will require facility to allocate correct CPM/CPC pricing to: |
| | | (i) General subscriber population |
| | | (ii) Specific profile(s) |
| 5.2.2 | | Cases 3 & 4 |
| | | Brand can bid for insertion when random selection. |
| | | The Brand should have the capability to target audience based on |
| | | profile parameters collected. |
| 5.3 | Reconciliation | |
| 5.3.1 | | Each Brand account should have the following parameters defined: |
| | | (i) Share of Monthly Fee to Causes |
| | | (ii) Share of CPM to Causes |
| | | (iii) Share of CPC to Causes |
| 5.3.1 | | Management alerts if: |
| | | Share of Monthly Fee to Causes <20% |
| | | Share of CPM to Causes <20% |
| | | Share of CPC to Causes <50% |
| 5.4 | Billing | |
| 5.4.1 | | Invoice: |
| | | Issue invoice: |
| | | (i) Defined Period: week or month |
| | | (ii) Defined Terms: immediate, 15 days, 30 days |
| 5.4.2 | | Recharge Account: |
| | | (i) Pre-paid funds |

### Reporting & Analysis

A range of reports will be required to provide.

### Provisioning

FREE2GIVE™ must deliver a global industrial strength service, with the dependable access that consumers demand.

| Ref. | Feature | Requirement |
|---|---|---|
| 8.1 | Hosting | Low-cost 3^{rd} party managed service, e.g. AWS |
| 8.1.2 | | Service Uptime |
| | | Minimum of 99.999 |
| 8.1.3 | | Capability to rapidly scale as the business demands |
| 8.1.4 | | 24x7 telephone support |
| 8.1.5 | | Concurrent support across multiple geographies |
| 8.2 | Parameters | Commercial grade service |
| 8.2.1 | | Redundancy |
| | | System should have load balancing to ensure that fall-over & fail-safe. |
| | | Including all the necessary alerts to trigger resolution to system |
| | | breakdown |
| 8.2.2 | | Recovery |
| | | All databases should be fully backed up on a daily basis & data stored |
| | | for rapid system recovery |
| 8.3 | Security | Multiple level system & data protection |
| 8.3.1 | | Systems must protect against unauthorised access. |
| | | External Systems: |
| | | Subscriber: user name & password |
| | | Brand/Cause: user name & password |
| | | Internal: graduating authority around data access |
| 8.3.2 | | Active steps to protect against malware, including viruses, trojans & |
| | | other malicious software |
| 8.4 | Languages | Support global business |
| 8.4.1 | | Primary language is UK English |
| 8.4.2 | | Other languages to be supported as defined |
| 8.5 | Systems | Future proof system design |
| 8.5.1 | | Databases & other system components, e.g. API, built using proven & |
| | | supported computer languages |
| 8.6 | Service | Ensure service remains high quality & working with defined |
| | Quality | parameters |
| 8.6.1 | | Daily check of Donation Mechanic insertion across all platforms & |
| | | bearers |

### 5. Business-Focussed Overview

High-level concepts implemented in the invention can be most readily understood from the following.

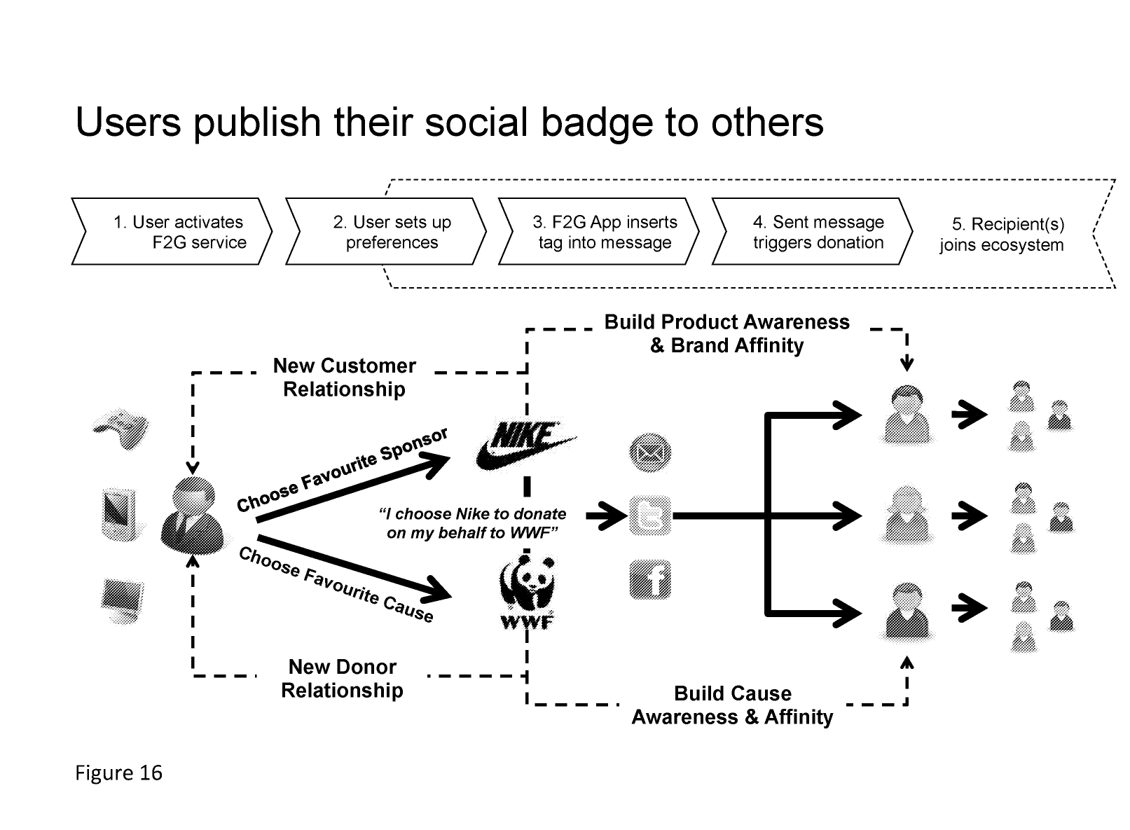

A schematic illustrating how users publish their ‘social badge’ to others is at FIG. 16. This is the mechanic/process of how an Advocacy Channel is created by its members. It shows how a user shares their Donation Mechanic (tag/social signature) and so distributes the opportunity for their community (recipients) and then their communities to both engage and enhance the outcome, and to also opt-in to likewise advocate the value of being Free2Give.

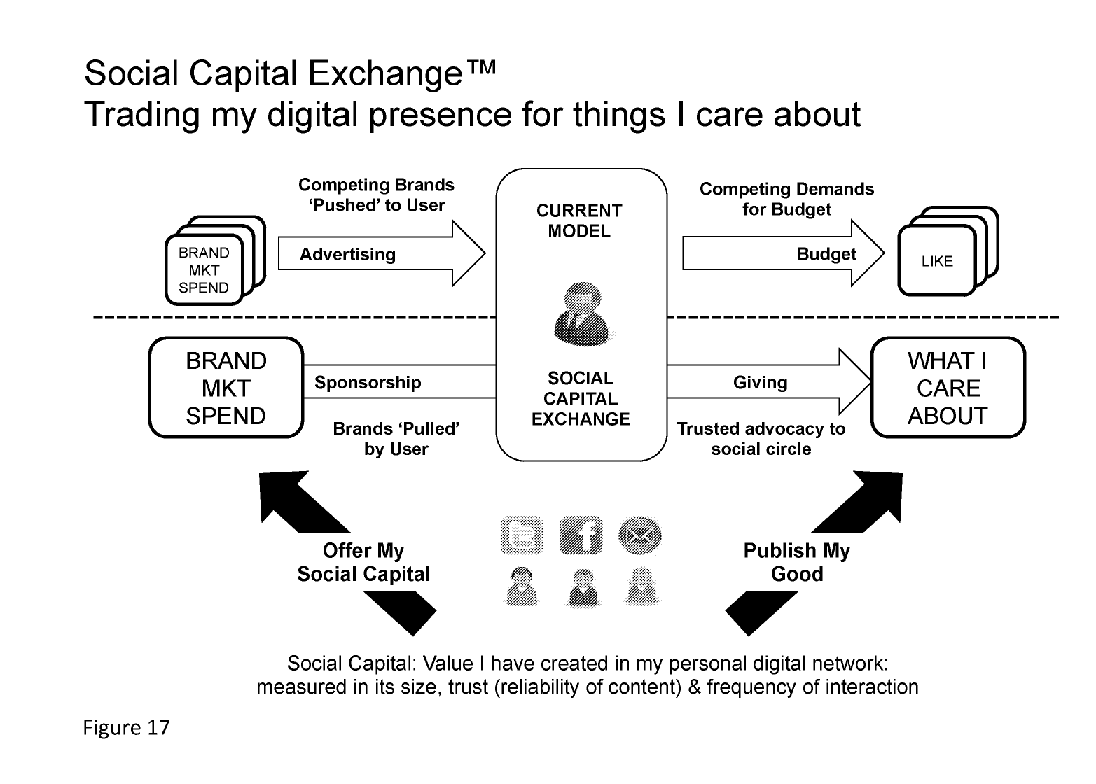

A schematic illustrating the ‘Social Capital Exchange’ model is at FIG. 17. This shows the difference between the traditional Push-Marketing model in which advertisers push adverts to users whether the users want it or not, vs. the new Pull-Marketing model where through Free2Give, users actively select and give Permission to brands to be present in their communications. The effect is that a Free2Give user is now positively and actively endorsing the brand and its intentions (donations) to causes to their communities, so creating clear advocacy and a channel through which such endorsements/propositions can be distributed reliably. And brands are no longer paying to have their message published, rather freely distributed by advocates to their communities for free.

It also shows what drives this channel, the exchange of social capital in return for doing good: what a user is trading in return for brand sponsorship/donation—the qualities of their network and their power to be an advocate within it.

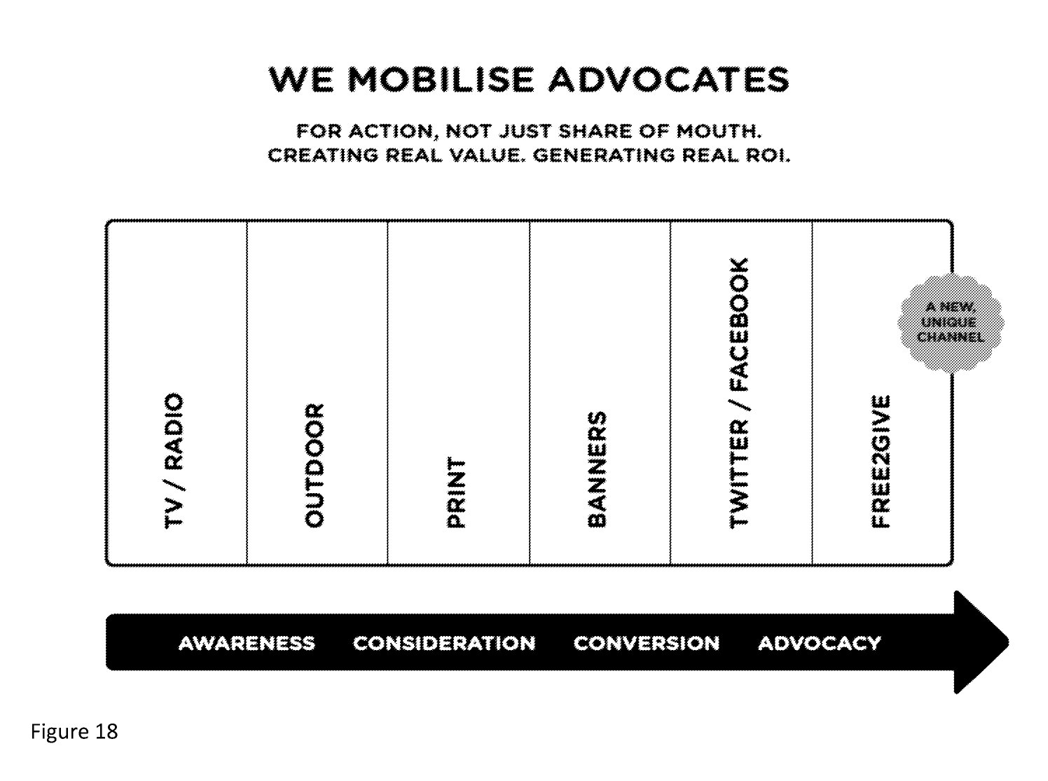

FIG. 18: this shows the role that Free2Give has for marketers and what outcome it creates in the process a user is typically expected to go through. Free2Give creates the ultimate outcome sought in one simple, 3-way relationship, namely Advocacy. As such, it delivers immediate impact on revenues for causes and brands and elegantly delivers (or avoids) all preceding elements that traditional marketing does in incremental steps.

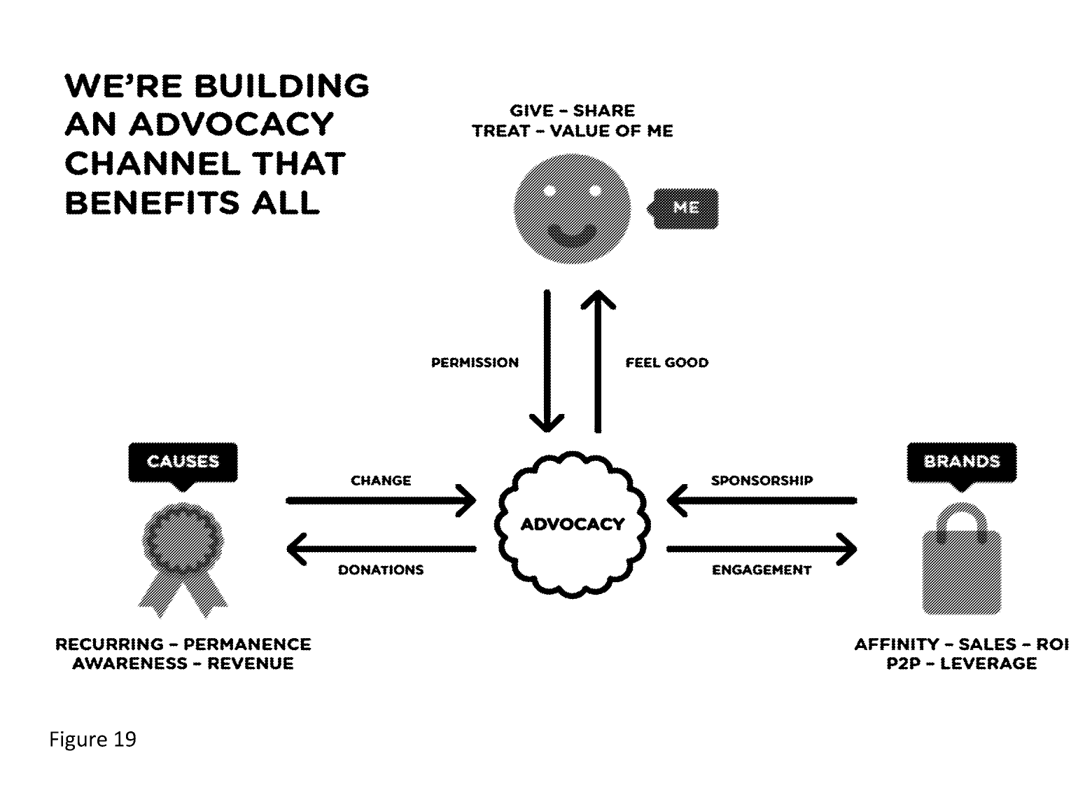

FIG. 19: this shows what each party is exchanging in the unique 3-way relationship that Free2Give forms, and what they get in return. It shows how the 3-way trade works between all parties: how we've created a system in which users trade social capital (permission) in exchange for a sponsor paying on their behalf to a cause; what causes trade in return for donations; and how brands access user advocacy via sponsorship of the individual, not directly to the cause. The symbiotic nature of this 3-way relationship is designed to enable Free2Give to be attractive and meaningful to millions of people, all causes and brands and so enable a new way in which we can all come together to do good

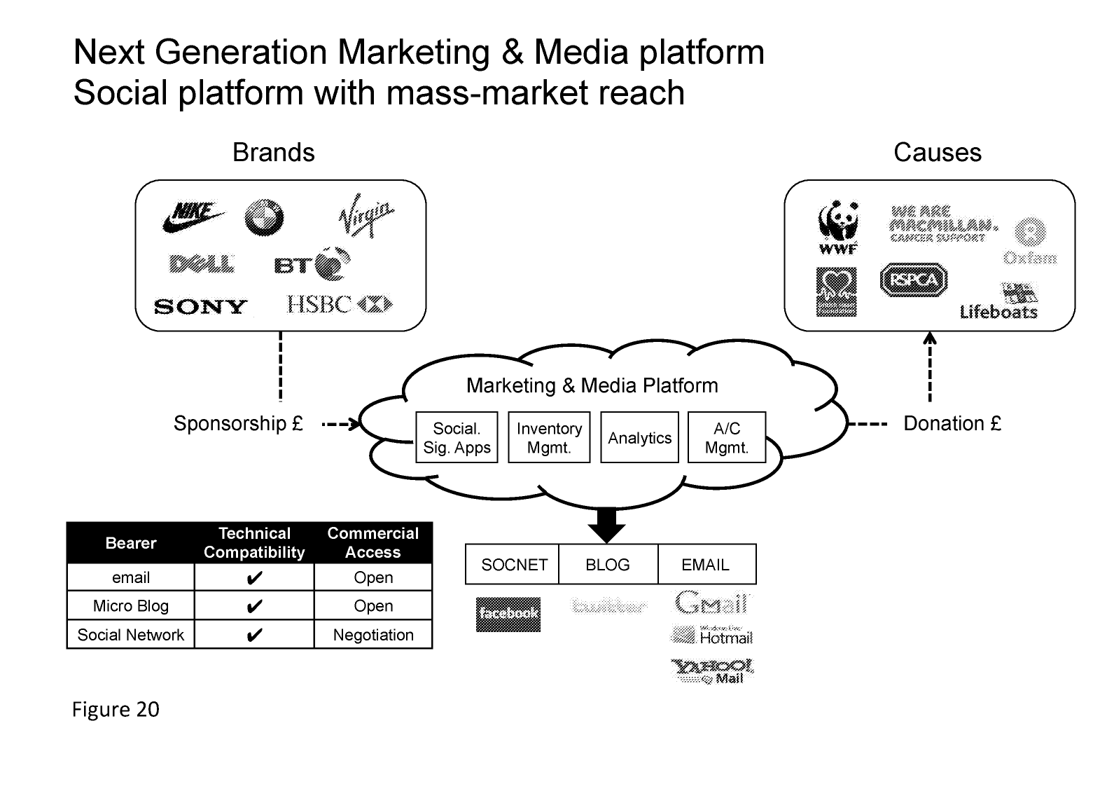

A schematic illustrating the ‘Next Generation Marketing & Media Platform’ is at FIG. 20. This shows that the new Pull-Marketing product is enabled by a standard media platform, but designing it to enable a 3-party relationship (user, brand, cause) and distribute this via any medium.

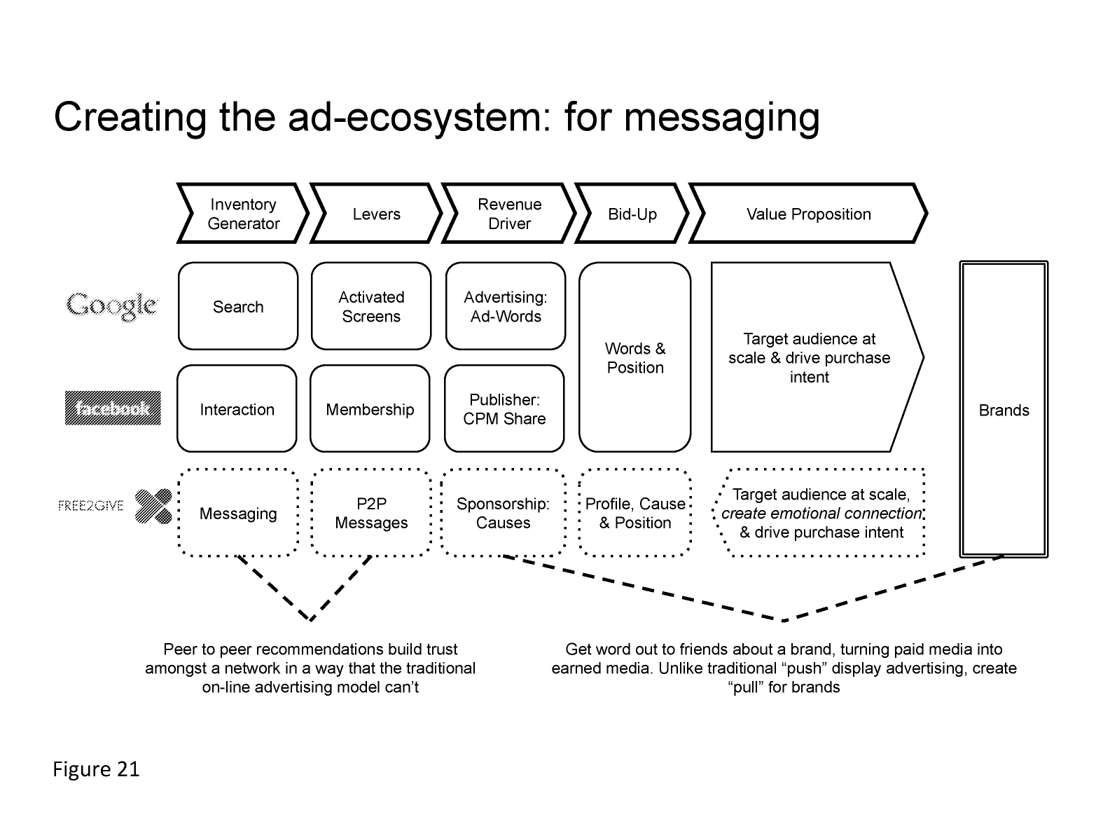

A schematic illustrating ‘Creating the ad-eco-system: for messaging’ is at FIG. 21. This shows how Free2Give has enabled access to Messaging for Brands (hitherto unavailable) and compares the features, mechanics/drivers and effectiveness at each stage off the value-chain. It shows that Free2Give is a lower cost, higher value system for distributing brand goodwill and engagement propositions, compared to traditional media currently employed.

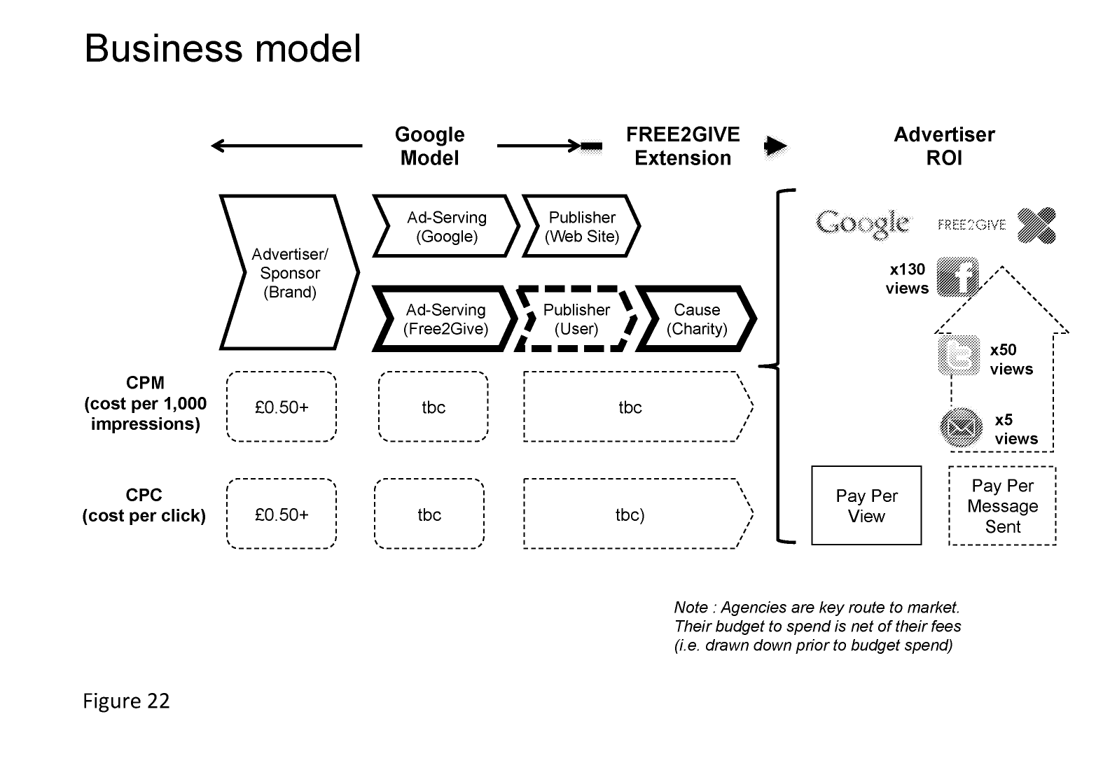

A schematic illustrating the ‘Business model’ is at FIG. 22. This now shows the impact of the Free2Give system design (shown in the previous figures) has on the performance of brand spend on advertising. It shows that Free2Give creates a significant uplift in outcomes/conversion to revenue and at lower cost, risk, etc. . . . .

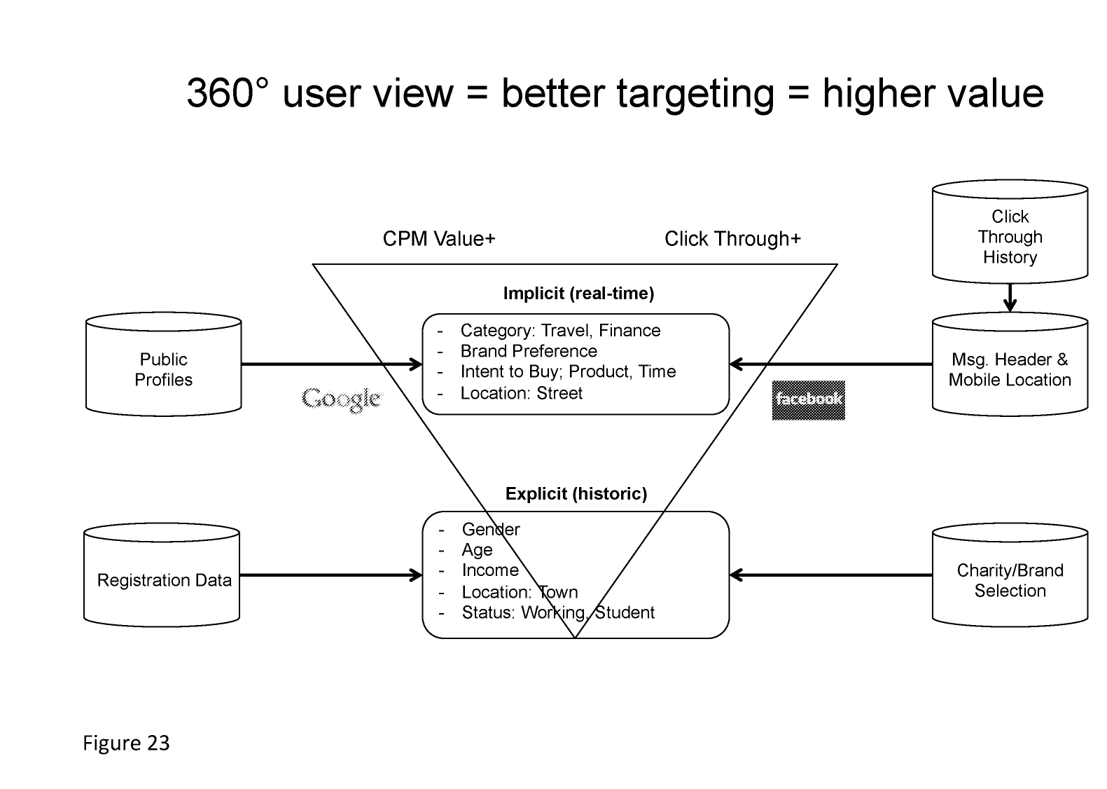

A schematic illustrating the ‘360° user view’ model is at FIG. 23. This now shows how the value of each user/viewer is enhanced compared to existing digital marketing/distributions systems such as Google and Facebook. It shows that the value of CPM and CPC are significantly enhanced in Free2Give because we have active permission, endorsement and high trust for users to share data about themselves, hence the marketing can be far more specific, relevant and critically valued and accepted by users/recipients.

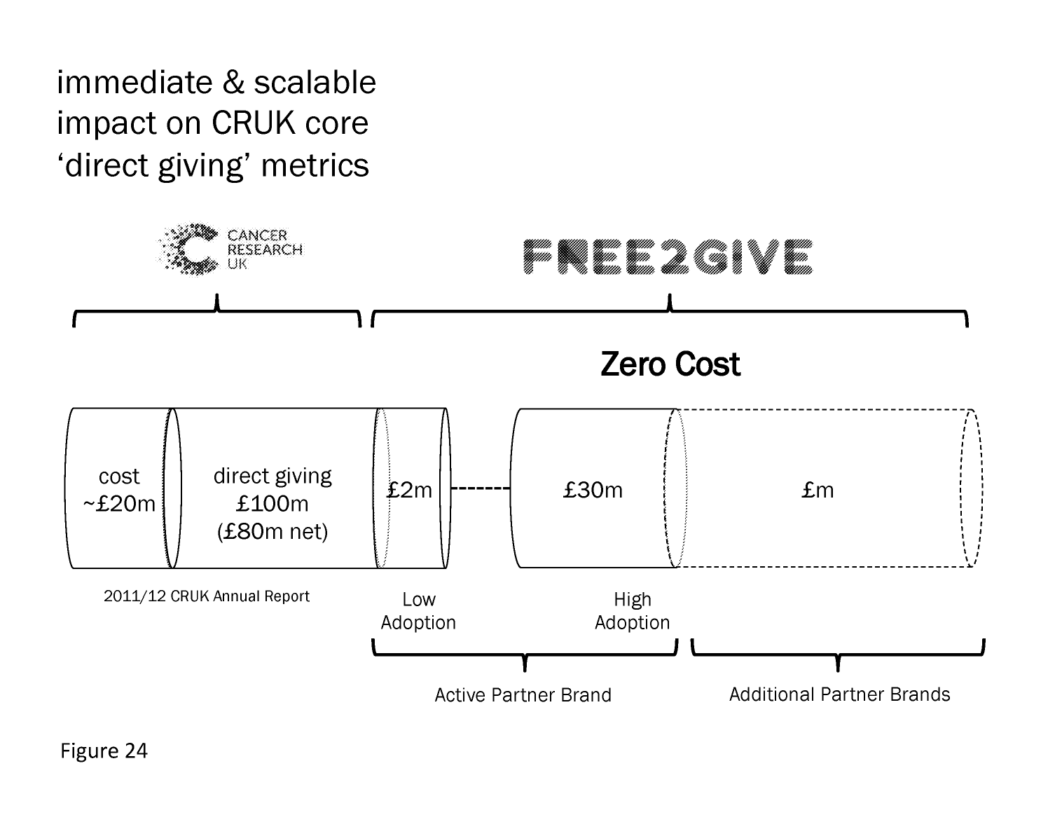

The Free2Give™ platform also provides an immediate & scalable impact on a Brand's core ‘direct giving’ metrics, as shown in FIG. 24. This shows the outcome of launching Free2Give with just one of Cancer Research UK's sponsoring brands. It shows that the incremental donations (revenue to CRUK) can range conservatively from £2 m p/a to over £30 m p/a. The range is driven by variables such as how widely CRUK communicate Free2Give to their base, how fast they adopt, what % click-through recipients exhibit when seeing the proposition, etc. . . . . And it shows that Free2Give product and systems are designed to ENHANCE a Cause/Brand's EXISTING marketing activities, communities and effectiveness of their marketing spend, so a low risk, high gain strategy.

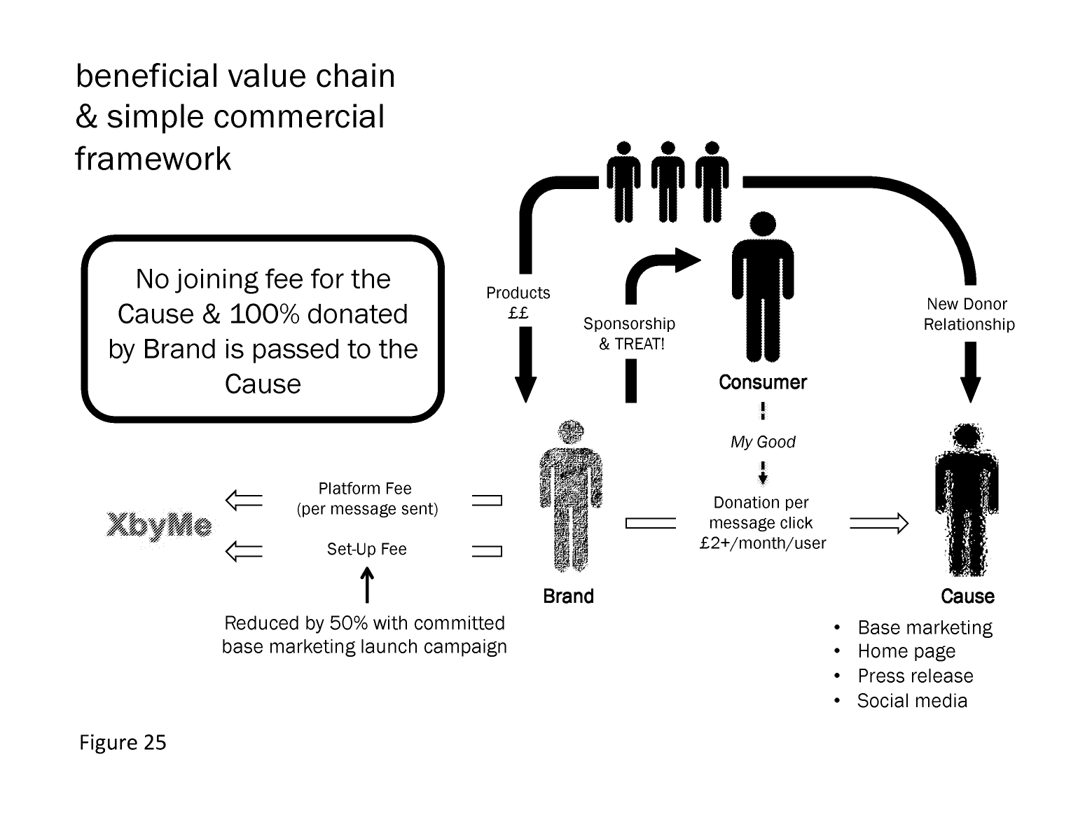

The beneficial value chain & simple commercial framework is shown in FIG. 25. This shows how value, benefits and revenues flow between the 3 main parties brokered through the Free2Give system.

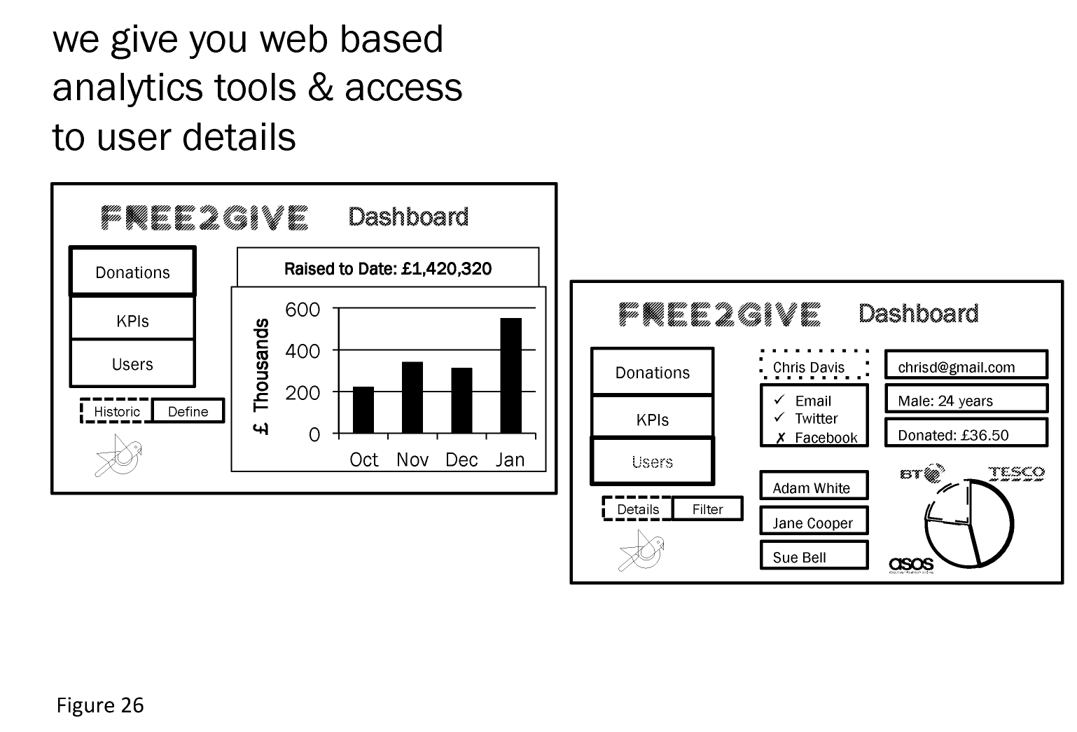

The Free2Give™ platform gives web based analytics tools & access to user details, as shown in FIG. 26; This shows the dash-board that a Cause and/or brand may see to monitor their account and campaign activity within Free2Give.

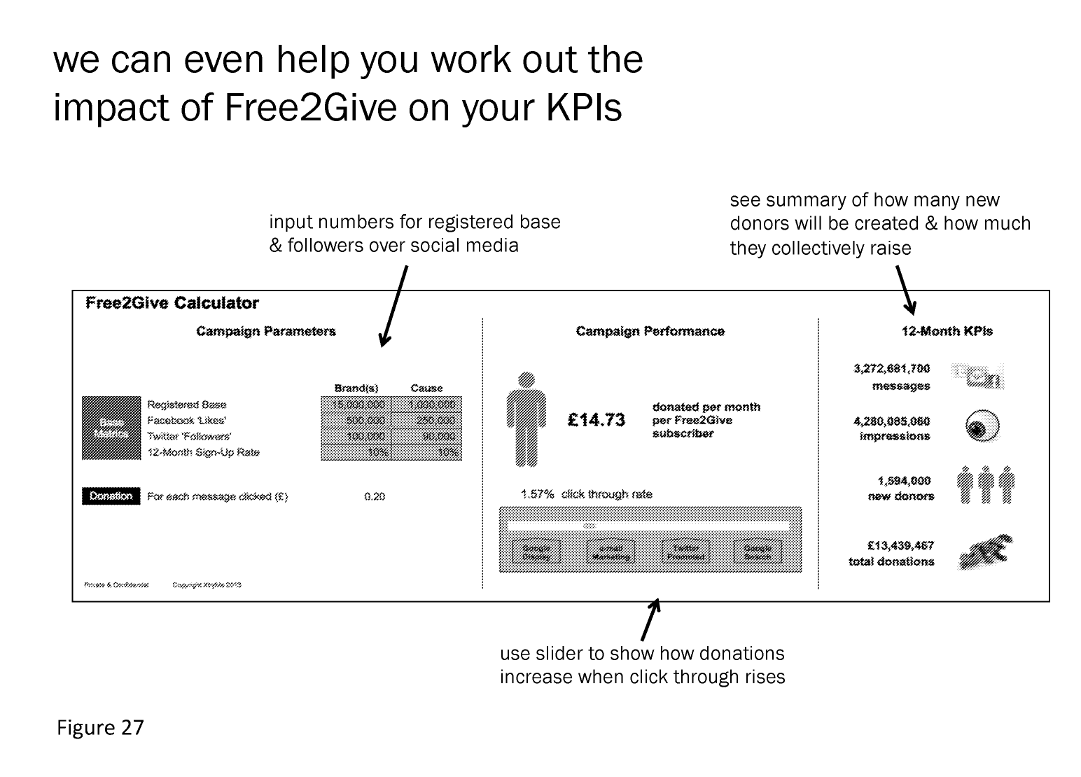

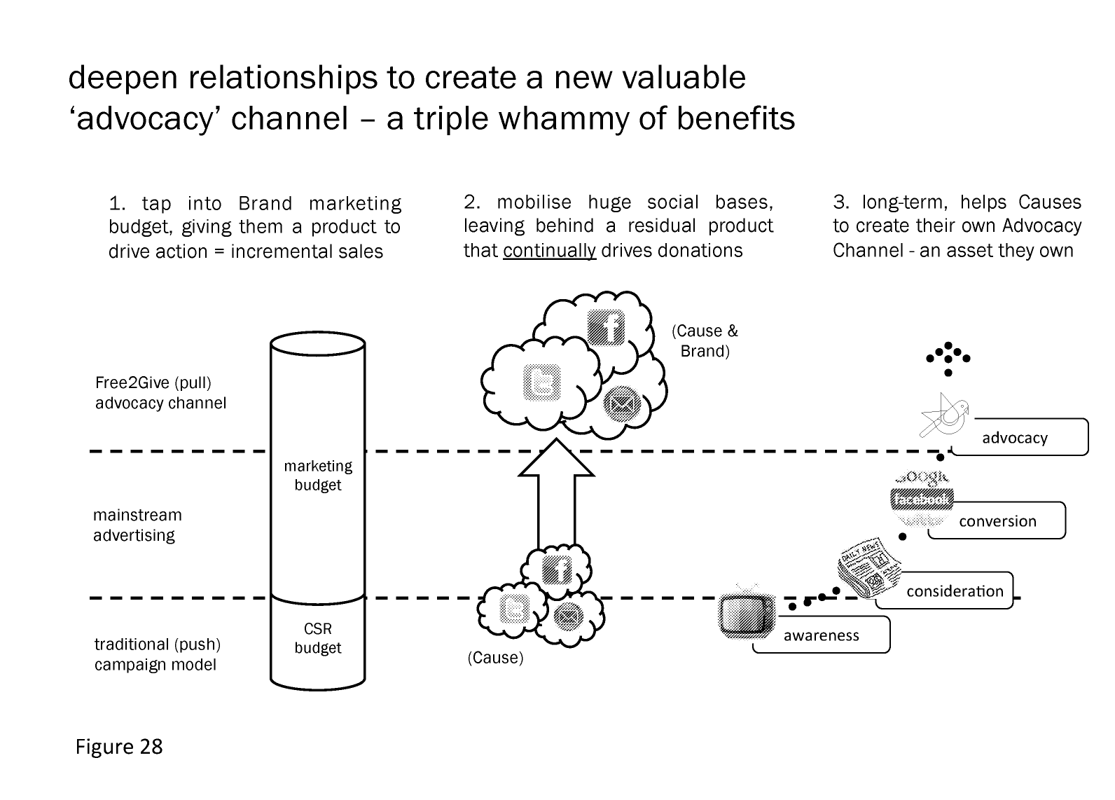

A ROI calculator is shown in FIG. 27. FIG. 28 shows how the Free2Give augmented messaging platform creates a new advocacy channel for Causes.

1. Method of automatically augmenting an electronic message, such as an email message, webmail, IM message, posting on a social network site, webpage or message in any other medium or format with pre-stored or dynamically generated content (a ‘Donation Mechanic’), such as text, graphics, audio or video, in which:
(a) a message sender, prior to sending the electronic message, selects or inputs to a computer some data, defining the type or name of a beneficiary, such as a charity or cause or a specifically named entity (a ‘Cause’), or permits the Cause to be remotely selected or confirmed;
(b) the computer and/or the remote server retrieve or dynamically create the Donation Mechanic, so that the Donation Mechanic includes or refers to or is otherwise based on the Cause;
(c) the computer and/or the remote server automatically inserts the Donation Mechanic into the electronic message.

2. The method of claim 1, where a plug-in or app, downloaded to the computer, enables the automatic augmenting of the electronic message.

3. The method of claim 1 in which the message sender selects one or more Causes from a list of possible Causes displayed on the computer.

4. The method of claim 1, in which a rules-based engine determines what Cause or Causes are appropriate to assign to the Donation Mechanic in the message.

5. The method of claim 1, in which the rules based engine determines dynamically for each message what Cause or Causes are appropriate to assign to the Donation Mechanic in the message.

6. The method of claim 1, in which the Cause is randomly selected at the message sender's computer or the remote server.

7. The method of claim 1, in which the computer and/or the remote server automatically selects the Cause based on the closest match between the profile of the message sender and criteria set by various Causes.

8. The method of claim 1, in which the computer and/or the remote server automatically selects the Cause based on the location of the message sender.

9. The method of claim 1, in which the computer and/or the remote server automatically selects the Cause based on presence information associated with the message sender, such as mood or status.

10. The method of claim 1, in which the computer and/or the remote server automatically assigns a Cause that has been pre-selected.

11. The method of claim 1, in which the computer and/or the remote server automatically allocates the same Cause to all active message bearers or message mediums associated with the message sender.

12. The method of claim 1, in which the computer and/or the remote server automatically allocates different Causes to different active message bearers or message mediums associated with the message sender.

13. The method of claim 1, in which the message sender, prior to sending the electronic message, selects or inputs to a computer some data, defining the type or name of an entity (the ‘Brand’) to be associated with the Donation Mechanic, such as being a sponsor that will pay for the Donation Mechanic, or permits the Brand to be remotely selected.

14-26. (canceled)

27. The method of claim 1, in which the computer and/or the remote server retrieves or dynamically creates the Donation Mechanic based on various parameters (‘Donation Mechanic Parameters’).

28-48. (canceled)

49. The method of claim 1, in which Donation Mechanic includes a portion, region or object, such as a plant or animal (‘Engagement Item’), that, when selected by the recipient, causes a new window, such as a browser window, to open and display information relevant to the Brand and/or Cause.

50-58. (canceled)

59. The method of claim 1, in which the message recipient receives, views or selects or clicks on the Donation Mechanic using his computer, then that computer sends a message to the remote server or another remote server that causes a signal to be sent to a payment server, defining or triggering a payment to the Cause.

60. The method of claim 1, in which the Engagement Item enables the message recipient to directly receive an offer, reward or other benefit (a ‘Treat’) by selecting the Engagement Item.

61-64. (canceled)

65. The method of claim 1, in which, when the message recipient selects an Engagement Item, a unique tracking URL enables the click details to be recorded, and the message recipient is re-directed to a corresponding destination web site.

66. (canceled)

67. The method of claim 1, in which the message sender can view all money (or equivalent currency/units) that he or she has raised for Causes on a website.

68-70. (canceled)

71. The method of claim 1, in which the computer or the remote server detects when a user selects a ‘share’ function or equivalent form of recommending/endorsement/sharing for any kind of content, such as a website, social media, or content personal to the user and then the computer and/or remote server automatically inserts a Donation Mechanic into whatever mechanism is used for the share function.

72-75. (canceled)

76. A method of sharing personal presence information in which:
(a) a user selects or inputs to a computer some data, defining the type or name of a beneficiary, such as a charity or cause or a specifically named entity (a ‘Cause’), or permits the Cause to be remotely selected;
(b) the user also selects or inputs data, defining the type or name of an entity (the ‘Brand’), being a sponsor that will provide a benefit in exchange for presence information of or linked to the user, or permits the Brand to be remotely selected;
(c) the computer provides, to a remote server, data enabling the Cause and the Brand to be determined; and
(d) the computer and/or remote server determines when a signal is sent that triggers or is otherwise associated with a payment from the Brand to the Cause.

77-79. (canceled)

80. A computer-implemented communication process, such as sending a message, posting to a social network, or sharing of a webpage, in which the process has a primary function to provide written information and also has a further function to enable the creator of the communication to exploit their reputation, knowledge, trustworthiness, or credibility (‘Social Capital’) by virtue of the medium of the communication, such as email message or social network posting, being automatically augmented by a computer using any of the above methods of automatically augmenting an electronic message.

81-86. (canceled)

87. The method of claim 1, in which the remote server includes one or more servers that perform the following functions: provisioning client applications, subscription management, analytics and CRM, media management.
